(19) United States
(12) Patent Application Publication
(10) Pub. No.: US 2026/0244749 A1
(43) Pub. Date: Aug. 20, 2026

(54) HARDENED AUTOMATION OF OS-LEVEL TASKS BY ARTIFICIAL INTELLIGENCE AGENTS WITH APPROVAL-BOUND EXECUTION AND TAMPER-EVIDENT PROVENANCE

(71) Applicant: Nirmal Singh Baid, Miami, FL (US)

(72) Inventor: Nirmal Singh Baid, Miami, FL (US)

(21) Appl. No.: 19/642,501

(22) Filed: Apr. 8, 2026

Related U.S. Application Data
(63) Continuation-in-part of application No. 19/349,934, filed on Oct. 3, 2025.
(63) Continuation-in-part of application No. 19/458,768, filed on Jan. 24, 2026.
(60) Provisional application No. 63/704,626, filed on Oct. 8, 2024.
(60) Provisional application No. 63/749,218, filed on Jan. 24, 2025.

(51) Int. Cl. G06F 21/57; G06F 21/51

(52) U.S. Cl. CPC G06F 21/57; G06F 21/51

(57) ABSTRACT

Methods, systems, and computer-readable media are described for hardened automation of operating-system-level tasks by an artificial intelligence agent. An agent gateway receives an agent request, binds the request to a session context, and constructs a workflow representation comprising operating-system-level input events and expected state transitions. A perception layer captures a pre-execution state artifact and computes a pre-execution hash. A policy engine determines an authorization decision based on a capability manifest. When approval is required, an approval request includes an action descriptor and the pre-execution hash, and an approval token cryptographically bound to the action descriptor and the pre-execution hash is validated. Immediately prior to execution, a current pre-execution hash is computed and execution is suppressed when the current pre-execution hash does not match. Post-execution state artifacts are used to verify state transitions, and a provenance module records hashes, authorization decisions, and approval metadata in a tamper-evident chained log.

### CROSS-REFERENCE TO RELATED APPLICATIONS

This application is a continuation-in-part of U.S. patent application Ser. No. 19/349,934, entitled AUTOMATING CODE ANALYSIS, DEPENDENCY MAPPING, AND ADAPTIVE TASK EXECUTION WITH AI, filed on Oct. 3, 2025, which claims the benefit of U.S. Provisional Patent Application No. 63/704,626, entitled SYSTEM AND METHOD FOR AUTOMATED CODE ANALYSIS, META TAGGING, DEPENDENCY MAPPING, AND DYNAMIC HELP DESK GENERATION USING AI, LLMS, GANS, AND MULTI-MODAL INTERFACES, filed on Oct. 8, 2024. The entire disclosures of the foregoing applications are incorporated herein by reference.

This application also claims the benefit, pursuant to 35 U.S.C. 120, of U.S. patent application Ser. No. 19/458,768, entitled SYSTEMS AND METHODS FOR DYNAMIC CONTEXT RETRIEVAL, CONTEXTUAL MEMORY, AND AUTONOMOUS SOFTWARE CREATION USING SWARM-BASED ORCHESTRATION AND EPHEMERAL VALIDATION, filed on Jan. 24, 2026, which claims the benefit of U.S. Provisional Patent Application No. 63/749,218, entitled DYNAMIC CONTEXT RETRIEVAL AND AUTONOMOUS SOFTWARE CREATION SYSTEM FOR CONVERSATIONAL AI, filed on Jan. 24, 2025. The entire disclosures of the foregoing applications are incorporated herein by reference.

### FIELD OF TECHNOLOGY

The present disclosure relates generally to artificial intelligence, computer systems, and automated software interaction.

More specifically, the disclosure relates to autonomous computing environments that are provisioned for an artificial intelligence agent and that support operating-system-level (OS-level) input events, perception-based state verification, workflow modeling, dependency mapping, multi-modal help output, and cryptographically verifiable provenance logging. The environments may be provisioned on virtual machines, containers, sandboxes, or other local computing substrates and may serve desktop, browser, and mobile clients.

### BACKGROUND

Modern software systems are increasingly complex. Applications commonly include nested menus, interdependent screens, multi-step configuration flows, error-driven branches, and complex dependencies among user-interface states. Many tasks require a sequence of precise GUI interactions, parameter settings, and verification steps.

Traditional automation approaches, such as script-based macros and robotic process automation (RPA) tools, are brittle. They often depend on static coordinates, template images, or rigid rule sets. When a user interface changes, when a dialog appears in a different location, or when timing varies, these scripts fail. Existing tools generally lack perception-based reasoning, robust verification of outcomes, or systematic provenance tracking of actions taken.

Large language models (LLMs) and other AI models can generate instructions, code fragments, or high-level task descriptions. However, prior systems do not provide a dedicated computing environment in which an AI agent can: (1) perform OS-level actions; (2) observe the resulting states through screenshots, document object model (DOM) structures, and accessibility trees; (3) verify that expected state transitions occurred; and (4) log all actions and state changes with cryptographic metadata for later audit.

The parent provisional and non-provisional applications describe systems that generate workflows containing OS-level events (cursor movements, keystrokes, mouse clicks, touch gestures, and command-line inputs) and use a perception layer to analyze screenshots, OCR output, DOM structures, and accessibility trees to verify state transitions. Those filings also describe cryptographic provenance modules that maintain tamper-evident logs of actions and states.

There remains a need for a dedicated, fully provisioned autonomous agent computing environment, referred to herein as an “agent computing environment,” “agent virtual computer,” or “AgentOS.” Such an environment should be instantiated for the exclusive use of an AI agent, should expose OS-level input and perception channels, should provide workflow execution and dynamic adaptation, and should maintain cryptographic provenance of all actions. The environment should operate with or without source-code access and should be compatible with existing help desk and documentation-generation systems described in the parent filings.

### SUMMARY

The disclosed subject matter provides autonomous agent computing environments that enable AI agents to perform multi-step tasks through OS-level interactions, perception-based verification, and secure provenance logging.

In one aspect, a method is provided for autonomous task execution in a provisioned computing environment. A server platform receives input data representing a task to be performed by an AI agent. An autonomous agent computing environment is provisioned that includes an operating system configured to receive OS-level input events. The AI agent constructs a workflow representation including a sequence of OS-level input events and expected state transitions. The workflow representation is executed by generating the input events within the environment. A perception layer captures pre-execution and post-execution states of the operating system and verifies whether each input event produced the expected state transition. A provenance module logs each input event and corresponding verified state transition using cryptographic metadata.

In another aspect, a system is provided comprising one or more processors, a memory, and an autonomous agent computing environment stored in the memory and executable by the processors. The environment includes an operating system configured to receive synthetic OS-level input events, a workflow execution component, a perception layer, and a provenance module.

In yet another aspect, a non-transitory computer-readable medium stores instructions that, when executed, provision the agent computing environment, generate workflow representations, execute OS-level events, capture pre-execution and post-execution states, verify state transitions, and record actions and state transitions in a cryptographically verifiable provenance log.

In certain embodiments, the agent computing environment further includes:
(a) a workflow generation engine that derives workflows from code analysis, documentation parsing, and autonomous UI exploration;
(b) a structured workflow graph comprising nodes that represent screens or states and edges that represent transitions or dependencies;
(c) a dependency mapping engine that identifies required data values, prerequisite screens, and ordering constraints;
(d) a multi-modal help desk engine that generates text, voice, diagram, screenshot, and annotated UI guidance from the workflow graph;
(e) mechanisms for dynamic workflow adaptation, including selection of fallback paths based on historical execution data; and
(f) support for multiple agent computing environments executing in parallel.

In some embodiments, mobile devices, browsers, or desktop clients act as remote controllers and presentation surfaces. A client device may submit task descriptions to a server platform that provisions the agent computing environment, executes workflows, and returns multi-modal help desk output. The client device may display the help content, control task initiation, and receive status updates, while the OS-level execution occurs within the agent computing environment.

The disclosed systems improve on prior automation and RPA approaches by providing: (i) a computing environment designed specifically for autonomous agents; (ii) integrated perception and verification at each step; (iii) tamper-evident cryptographic provenance logs; (iv) operation with or without source code; and (v) structured workflow graphs that can drive multi-modal help desk experiences.

### BRIEF DESCRIPTION OF THE DRAWINGS

FIG. 1 is a system diagram illustrating an autonomous task execution component interacting with multiple client devices, a cloud platform, and a data center.

FIG. 2 is a block diagram of a workflow automation component including a data receiving component, a task parsing component, a workflow execution component, a perception layer component, and a provenance logging component.

FIG. 3 is a flow diagram showing receiving input data, provisioning a computing environment, executing a workflow representation, verifying state transitions, and logging events with metadata.

FIG. 4 is a block diagram of an autonomous task execution component including a task receiving component, a computing environment provisioning component, a workflow execution component, a state verification component, and a provenance logging component.

FIG. 5 is a block diagram of an extended component set that further includes a fallback workflow generation component, an accessibility metadata capturing component, a virtual input emulation component, a task parameter parsing component, and a cryptographic metadata storage component.

FIG. 6 is a block diagram of a computing device that may host an autonomous task execution component, including a processor, memory, database controller, I/O controller, and database.

FIG. 7 is a flow diagram of a method in which a server platform provisions a computing environment, executes a workflow, verifies state transitions, and logs events with metadata.

FIG. 8 is a flow diagram of a method in which a client device receives a provisioned computing environment, executes a workflow locally within that environment, and logs events with associated cryptographic metadata.

FIG. 9 is a flow diagram illustrating approval-bound execution in which a pre-execution state artifact is hashed, an approval request includes the pre-execution hash, a hash-match gate suppresses execution on mismatch, and a tamper-evident provenance chain is recorded.

### DETAILED DESCRIPTION

The detailed description that follows enables one of ordinary skill in the art to make and use the disclosed autonomous agent computing environments. The terminology used in this description is intended to be interpreted in a non-limiting manner. The embodiments described below may be combined or modified in various ways while remaining within the scope of the claims.

Methods, systems, devices, and apparatuses that support techniques for autonomously executing tasks with perception and secure provenance in computing environments are disclosed. In some examples, existing automation tools may be constrained by their reliance on static scripts, brittle rule sets, and limited perception capabilities. These systems may be unable to adapt to dynamic changes in user interfaces, unexpected software states, or errors encountered during task execution. Furthermore, they may lack the ability to validate task outcomes using perception-driven techniques, such as optical character recognition, accessibility tree analysis, or document object model comparisons. Current solutions may also fail to provide cryptographically secure provenance tracking, which may be essential for auditability and compliance in enterprise applications. The absence of a dedicated computing environment optimized for autonomous artificial intelligence agents may further limit the ability of such systems to perform tasks requiring operating-system-level interaction, perception-based validation, and secure logging. These deficiencies may create significant barriers to the reliable and scalable deployment of autonomous artificial intelligence agents in real-world scenarios.

In some implementations, a system may provide a dedicated computing environment specifically designed for autonomous artificial intelligence (AI) agents to execute tasks without human intervention. This environment may be instantiated in various forms, such as virtual machines, containerized execution environments, remote desktop sessions, sandboxed execution contexts, or cloud-hosted desktop instances. The environment may be capable of running applications and workflows without requiring modifications to the underlying software, ensuring compatibility with a wide range of systems. To facilitate autonomous operation, the environment may include an operating system configured to receive synthetic input events, such as cursor movements, mouse clicks, keystrokes, touch gestures, and command-line inputs. These input events may be generated by a workflow execution engine and injected into the operating system using methods like driver emulation, windowing-system application programming interfaces (APIs), or application-level automation hooks, enabling interaction with graphical user interfaces, browser-based elements, or accessibility interfaces.

The operating system within the environment may support multi-modal interaction models, allowing the AI agent to process diverse input types, including text instructions, voice commands, graphical elements, embedded documentation, media files, and screenshots. To monitor and verify the outcomes of these interactions, the environment may include a perception layer that captures and analyzes state transitions within the operating system. This perception layer may record pre-execution and post-execution states, using methods such as screenshot capture, optical character recognition (OCR) for text extraction, accessibility tree metadata analysis, document object model (DOM) data examination for browser-based applications, pixel-difference analysis for visual changes, and tracking of active window metadata. By comparing these states, the perception layer may determine whether expected changes occurred and, if discrepancies are detected, may trigger fallback workflows or recovery actions to address errors or unexpected outcomes. In some embodiments, the operating-system-level input events interact with a browser or webview user interface, and the perception layer captures at least one of rendered pixels, an accessibility tree snapshot, or a document object model snapshot associated with the browser or webview.

The workflow execution engine may play a central role in constructing and executing workflows, which may consist of sequences of operating-system-level input events, conditional branches, fallback paths, and error-handling triggers. These workflows may be generated by analyzing input data, such as source code, documentation, user-provided descriptions, or graphical interface elements. In cases where source code may be unavailable, the engine may autonomously explore graphical user interfaces to infer task flows. This exploration may involve generating input events, capturing screenshots, analyzing interface structures, and leveraging insights from the perception layer to construct workflows. Additionally, the workflow execution engine may optimize the timing between sequential actions to improve efficiency and ensure smooth task execution. The system may also support dynamic workflow adaptation, allowing workflows to adjust in response to errors or unexpected states by referencing historical fallback workflows, substituting alternative input events, or re-planning tasks using updated state information.

To ensure the integrity and traceability of operations, the environment may include a cryptographic provenance module that securely logs each input event and its corresponding verified state transition. These logs may contain timestamps, event identifiers, cryptographic hashes of pre-execution and post-execution states, workflow instance identifiers, and agent identity credentials. The provenance module may store these logs in a cryptographically verifiable ledger, making the data tamper-evident and enabling integrity checks to verify authenticity. This module may also support forensic reconstruction of workflows, replay functionality for debugging, and compliance assessments. Furthermore, the system may gather telemetry data to optimize performance and maintain reliability. This telemetry data may include metrics such as central processing unit (CPU) usage, memory consumption, input-event timing statistics, perception-layer processing times, and provenance log integrity checks, which may be used to refine workflows, detect anomalies, and ensure operational validity.

The system may support scalable deployment of multiple autonomous agent computing environments, each operating independently while maintaining its own provenance logs. Distributed execution may involve load balancing across cloud regions or data centers, synchronization of workflows across multiple environments, and parallel execution of different tasks. Coordination among multiple agents may be facilitated through communication with a central orchestration system, enabling collaborative task execution. The environment may also be provisioned dynamically based on task requirements, which may involve instantiating virtual machines, containers, or remote desktop sessions; loading necessary applications and resources; and configuring access controls for file systems, network policies, and user interfaces. To enhance functionality, the environment may integrate with external systems, such as code repositories, help desk systems, enterprise ticketing platforms, knowledge bases, logging systems, and security monitoring systems, allowing it to receive task parameters, execute workflows, and return results to these systems.

Security may be a critical aspect of the environment, which may include measures to ensure secure and isolated execution of workflows. These measures may involve process-level isolation using hypervisors, container security boundaries, restricted file-system permissions, sandboxed network access, limited system-call surfaces, virtualized display buffers, and non-privileged execution modes for agent actions. These features may prevent unauthorized access to the environment and ensure that agent actions remain confined to their designated execution domain. Additionally, the environment may support snapshot-based resets to return to a known-good state, step-by-step replay of prior workflows for debugging, forensic reconstruction of workflows using provenance logs, and rollback functionality to recover from errors. The environment may be implemented on various platforms, including server hardware, virtualized machines, container runtimes, remote desktop services, mobile devices, and desktop operating systems, supporting event injection, perception capture, workflow execution, and provenance logging.

Aspects of the subject matter described in this disclosure can be implemented to realize one or more of the following potential advantages. The described techniques may be implemented to support autonomous task execution with enhanced adaptability and precision by leveraging multi-modal perception and dynamic workflow generation. The system may enable AI agents to operate in environments where traditional automation tools may fail due to rigid scripting or lack of adaptability. The described computing environment may facilitate seamless interaction with diverse software systems, even in scenarios where direct integration or source code access may not be available. The use of cryptographic provenance logging may ensure secure and tamper-evident records of all actions, which may enhance auditability and compliance in enterprise settings. The system may dynamically adjust workflows in response to unexpected states, which may improve reliability and reduce downtime during task execution. By supporting isolated execution domains, the environment may provide robust security measures that prevent unauthorized access and ensure operational integrity. The techniques may also allow for scalable deployment across distributed systems, enabling efficient task execution in cloud-based or on-premise infrastructures.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to autonomously executing tasks with perception and secure provenance in computing environments.

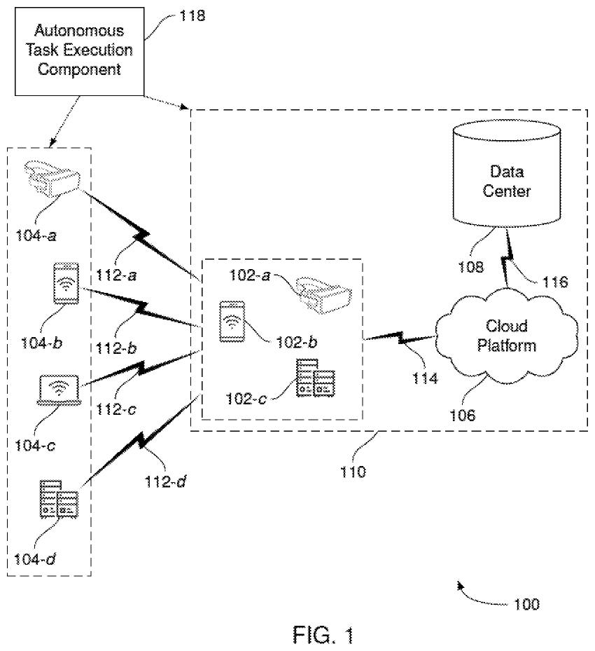

FIG. 1 illustrates an example of a system 100 that supports autonomously executing tasks with perception and secure provenance in computing environments in accordance with various aspects of the present disclosure. The system 100 includes cloud clients 102, user devices 104, a cloud platform 106, and a data center 108. Cloud platform 106 may be an example of a public or private cloud network. A cloud client 102 may access cloud platform 106 over a network connection 114. The network connection 114 may include a wired connection, a wireless connection, or both. The network may implement transmission control protocol and internet protocol (TCP/IP), such as the Internet, or may implement other network protocols. A cloud client 102 may be an example of a computing device, such as a wearable device (e.g., cloud client 102-a), a smartphone (e.g., cloud client 102-b), or a server (e.g., cloud client 102-c). In other examples, a cloud client 102 may be a desktop or laptop computer, a tablet, a sensor, or another computing device or system capable of generating, analyzing, transmitting, or receiving communications. In some examples, a cloud client 102 may be part of a business, an enterprise, a non-profit, a startup, or any other organization type.

A cloud client 102 may facilitate communication between the data center 108 and one or multiple user devices 104 to implement an online environment. The network connection 112 may include communications, opportunities, purchases, sales, or any other interaction between a cloud client 102 and a user device 104. The network connection 112 may include a wired connection, a wireless connection, or both. A cloud client 102 may access cloud platform 106 to store, manage, and process the data communicated via one or more network connections 112. In some cases, the cloud client 102 may have an associated security or permission level. A cloud client 102 may have access to certain applications, data, and database information within cloud platform 106 based on the associated security or permission level, and may not have access to others.

The user device 104 may include an autonomous task execution component 118. The user device 104 may interact with the cloud client 102 over network connection 112. The network may implement transmission control protocol and internet protocol (TCP/IP), such as the Internet, or may implement other network protocols. The network connection 112 may facilitate transport of data via email, web, text messages, mail, or any other appropriate form of electronic interaction (e.g., network connections 112-a, 112-b, 112-c, and 112-d) via a computer network. In an example, the user device 104 may be computing device such as a wearable device 104-a, a smartphone 104-b, a laptop 104-c or a server 104-d. In other cases, the user device 104 may be another computing system. In some cases, the user device 104 may be operated by a user or group of users. The user or group of users may be a customer, associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud clients 102 with a single instance of software. However, other types of systems may be implemented, including—but not limited to—client-server systems, mobile device systems, and mobile network systems. In some cases, cloud platform 106 may support an online application. This may include support for sales between buyers and sellers operating user devices 104, service, marketing of products posted by buyers, community interactions between buyers and sellers, analytics, such as user-interaction metrics, applications (e.g., computer vision and machine learning), and the Internet of Things (IoT). Cloud platform 106 may receive data associated with generation of an online environment from the cloud client 102 over network connection 114, and may store and analyze the data. In some cases, cloud platform 106 may receive data directly from a user device 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or via network connection 112 between a user device 104 and the cloud client 102. The connection 116 may include a wired connection, a wireless connection, or both. Data center 108 may utilize multiple redundancies for security purposes. In some cases, the data stored at data center 108 may be backed up by copies of the data at a different data center (not pictured).

Server system 110 may include cloud clients 102, a cloud platform 106, an autonomous task execution component 118, and a data center 108 that may coordinate with cloud platform 106 and data center 108 to implement an online environment. In some cases, data processing may occur at any of the components of server system 110, or at a combination of these components. Thus, the autonomous task execution component 118 may be included in the user device 104, server system 110, or in part or in whole in both. In some cases, servers may perform the data processing. The servers may be a cloud client 102 or located at data center 108.

Some or all of the functionality attributed to the autonomous task execution component 118 may be embodied or performed by one or more user devices 104, one or more components of server system 110 (e.g., cloud clients 102, a cloud platform 106, and/or a data center 108), and/or other components of system 100. The autonomous task execution component 118 may receive signals and inputs from user device 104 directly, via cloud clients 102, and/or via cloud platform 106 or data center 108.

As described herein, some implementations may utilize the autonomous task execution component 118 to provision a dedicated computing environment within the user device 104 or server system 110. This computing environment may include an operating system configured to receive synthetic input events and a perception layer capable of capturing pre-execution and post-execution states associated with a task. The autonomous task execution component 118 may execute workflows corresponding to tasks by generating synthetic input events within the operating system and may verify state transitions using the perception layer. Cryptographic metadata associated with the synthetic input events and verified state transitions may be securely logged in a provenance module, which may be integrated into the user device 104, server system 110, or both.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

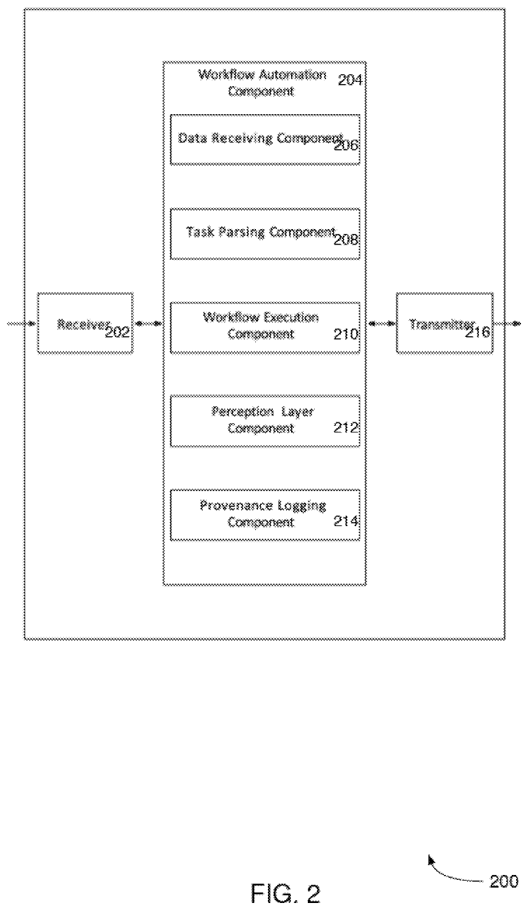

FIG. 2 shows component block diagram 200 which supports techniques for autonomously executing tasks with perception and secure provenance in computing environments in accordance with various aspects of the present disclosure. As depicted in FIG. 2, the component block diagram 200 may include one or more of a receiver 202, a workflow automation component 204, a data receiving component 206, a task parsing component 208, a workflow execution component 210, a perception layer component 212, a provenance logging component 214, a transmitter 216, and/or other components.

The receiver 202 may include hardware or software configured to accept input data related to tasks for autonomous execution. The receiver 202 may include interfaces such as network adapters, APIs, or file upload modules to handle incoming task-related data. The receiver 202 may process data in various formats, including structured files, unstructured text, or multimedia inputs. The receiver 202 may interact with the data receiving component 206 to transfer the accepted input data for further processing. In some implementations, the receiver 202 may include mechanisms to validate the integrity or authenticity of the input data before passing it to other components.

The workflow automation component 204 may include mechanisms to generate and manage workflows based on the input data received. The workflow automation component 204 may determine task parameters and construct workflows that include sequences of operating-system-level input events. The workflow automation component 204 may store workflow representations in a database or memory for execution by the workflow execution component 210. The workflow automation component 204 may interact with the task parsing component 208 to extract actionable parameters from the input data. In some implementations, the workflow automation component 204 may support dynamic updates to workflows based on real-time feedback from the perception layer component 212.

The data receiving component 206 may include interfaces or modules to handle incoming data streams or files for processing. The data receiving component 206 may support various data formats, including JSON, XML, CSV, or binary files. The data receiving component 206 may preprocess the incoming data to ensure compatibility with downstream components. The data receiving component 206 may interact with the receiver 202 to retrieve input data and pass it to the task parsing component 208. In some implementations, the data receiving component 206 may include error-handling mechanisms to address issues such as incomplete or corrupted data.

The task parsing component 208 may include logic to analyze and interpret task-related data to extract actionable parameters. The task parsing component 208 may use natural language processing, pattern recognition, or rule-based algorithms to determine task parameters. The task parsing component 208 may store extracted parameters in a structured format for use by the workflow automation component 204. The task parsing component 208 may interact with the data receiving component 206 to access the input data for analysis. In some implementations, the task parsing component 208 may support multi-modal data inputs, such as text, images, or audio.

The workflow execution component 210 may include systems to perform operating-system-level input events based on the generated workflows. The workflow execution component 210 may generate synthetic input events such as cursor movements, keystrokes, mouse clicks, or touch gestures. The workflow execution component 210 may execute workflows in a virtualized or containerized environment to ensure isolation. The workflow execution component 210 may interact with the perception layer component 212 to capture pre-execution and post-execution states. In some implementations, the workflow execution component 210 may include mechanisms to handle errors or unexpected states during execution.

The perception layer component 212 may include tools to capture and analyze pre-execution and post-execution states of the computing environment. The perception layer component 212 may use techniques such as screenshot capture, optical character recognition, or accessibility tree parsing to determine system states. The perception layer component 212 may compare captured states to expected states defined in the workflow representation. The perception layer component 212 may interact with the workflow execution component 210 to receive execution context information. In some implementations, the perception layer component 212 may include multi-modal analysis capabilities to combine data from different sources.

The provenance logging component 214 may include structures to record input events and state transitions with cryptographic metadata. The provenance logging component 214 may store logs in a tamper-evident ledger to ensure auditability. The provenance logging component 214 may record details such as timestamps, event identifiers, and hash values of captured states. The provenance logging component 214 may interact with the workflow execution component 210 to receive information about executed input events. In some implementations, the provenance logging component 214 may support integration with external systems for compliance or reporting purposes.

The transmitter 216 may include functionality to send processed data, logs, or results to external systems or devices. The transmitter 216 may support communication protocols such as HTTP, WebSocket, or MQTT for data transmission. The transmitter 216 may send data to cloud platforms, enterprise systems, or user devices. The transmitter 216 may interact with the provenance logging component 214 to retrieve logs for transmission. In some implementations, the transmitter 216 may include mechanisms to encrypt data before transmission to ensure security.

In some implementations, the receiver 202 may be configured to accept input data, such as user requests, codebases, or documentation, and transmit this data to the data receiving component 206. The data receiving component 206 may process the input data and forward it to the task parsing component 208, which may analyze the data to determine the sequence of tasks or workflows to be executed. The task parsing component 208 may generate a workflow representation that includes operating-system-level input events, expected state transitions, and error-handling mechanisms, and then pass this representation to the workflow execution component 210.

In some implementations, the workflow execution component 210 may execute the workflow by generating synthetic input events, such as cursor movements, keystrokes, or touch gestures, and injecting them into the operating system. The perception layer component 212 may monitor the system's state by capturing pre-execution and post-execution data, such as screenshots, DOM attributes, or accessibility tree snapshots, to determine whether the executed input events resulted in the expected state transitions. The provenance logging component 214 may record the input events, state transitions, timestamps, and cryptographic metadata in a tamper-evident ledger to maintain a secure and auditable record of the operations. The transmitter 216 may send the results of the workflow execution, including perception-layer outputs and provenance logs, to external systems or users for further processing or review.

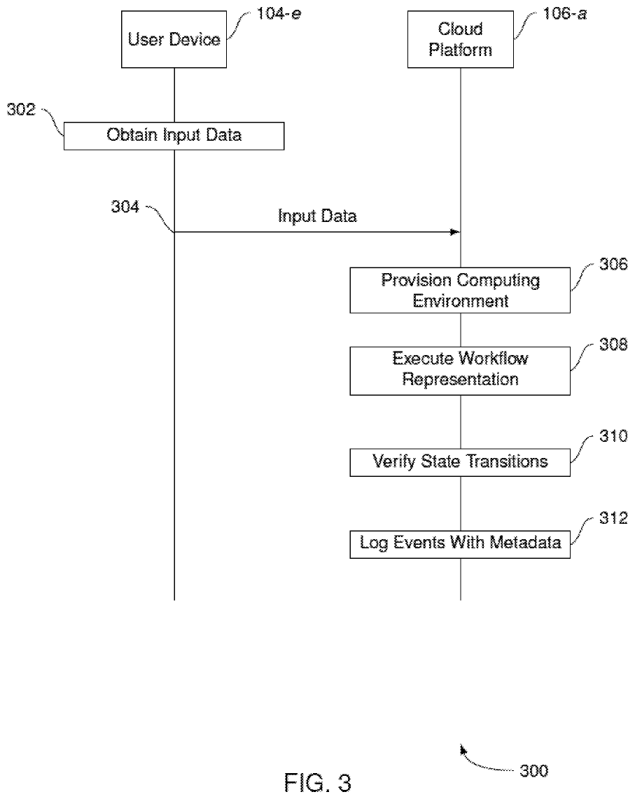

FIG. 3 illustrates an example of a process flow 300 that supports autonomously executing tasks with perception and secure provenance in computing environments in accordance with aspects of the present disclosure. In some examples, the process flow 300 may implement aspects of the system 100. For example, the process flow 300 may include a user device 104-e and a cloud platform 106-a, which may be examples of corresponding devices described herein. In some implementations, a user device 104-e transmits input data representing a task to a cloud platform 106-a, which provisions a computing environment with an operating system and perception layer, executes the task using synthetic input events, verifies state transitions through the perception layer, and logs the events and verified transitions with cryptographic metadata in a provenance module.

At 302, the user device 104-e may obtain input data representing a task to be performed by an artificial intelligence agent. For example, the input data may include a natural language description of the task provided by a user through a text interface on the user device 104-e. In some implementations, the input data may include metadata extracted from a document or file uploaded to the user device 104-e. The user device 104-e may determine task parameters by parsing structured data, such as JSON or XML, received from an external system.

At 304, the user device 104-e may transmit the input data to the cloud platform 106-a. For example, the user device 104-e may send the input data as a structured data packet formatted in JSON or XML to ensure compatibility with the cloud platform 106-a. In some implementations, the user device 104-e may encrypt the input data before transmission to maintain data security during transfer to the cloud platform 106-a. The user device 104-e may transmit the input data over a secure communication protocol, such as HTTPS or TLS, to the cloud platform 106-a.

At 306, the cloud platform 106-a may provision a computing environment including an operating system configured to receive synthetic input events and a perception layer configured to capture pre-execution and post-execution states of the operating system. For example, the cloud platform 106-a may instantiate a virtual machine preloaded with software tools required for the task or may deploy a containerized execution environment with restricted access to specific applications. In some implementations, the perception layer may include modules for capturing screenshots, analyzing accessibility tree metadata, or performing optical character recognition to detect changes in the operating system state. The cloud platform 106-a may configure the computing environment to include a virtual display buffer for rendering graphical user interfaces and capturing visual data for state verification.

At 308, the cloud platform 106-a may execute a workflow representation of the task within the computing environment by generating the synthetic input events. For example, the cloud platform 106-a may generate synthetic input events such as cursor movements, keystrokes, or mouse clicks to interact with graphical user interfaces within the computing environment. In some implementations, the synthetic input events may include touch gestures or command-line inputs to simulate user interactions with specific applications. The cloud platform 106-a may determine the sequence and timing of the synthetic input events based on the workflow representation to ensure accurate task execution.

At 310, the cloud platform 106-a may verify, using the perception layer, state transitions based on the captured pre-execution and post-execution states. For example, the cloud platform 106-a may compare pixel-level differences between pre-execution and post-execution screenshots to determine whether a graphical user interface element has changed. In some implementations, the cloud platform 106-a may analyze accessibility tree metadata to identify updates in the roles or states of user interface components. The cloud platform 106-a may perform optical character recognition on text elements within the captured screenshots to determine whether specific text fields or labels have been modified.

At 312, the cloud platform 106-a may log, in a provenance module, each synthetic input event and corresponding verified state transition, the log may include cryptographic metadata associated with the task. For example, the provenance module may store a hash value of the pre-execution and post-execution states alongside a timestamp for each logged event. In some implementations, the provenance module may associate the cryptographic metadata with a unique identifier for the AI agent performing the task. The provenance module may further include a tamper-evident ledger to record the sequence of synthetic input events and verified state transitions.

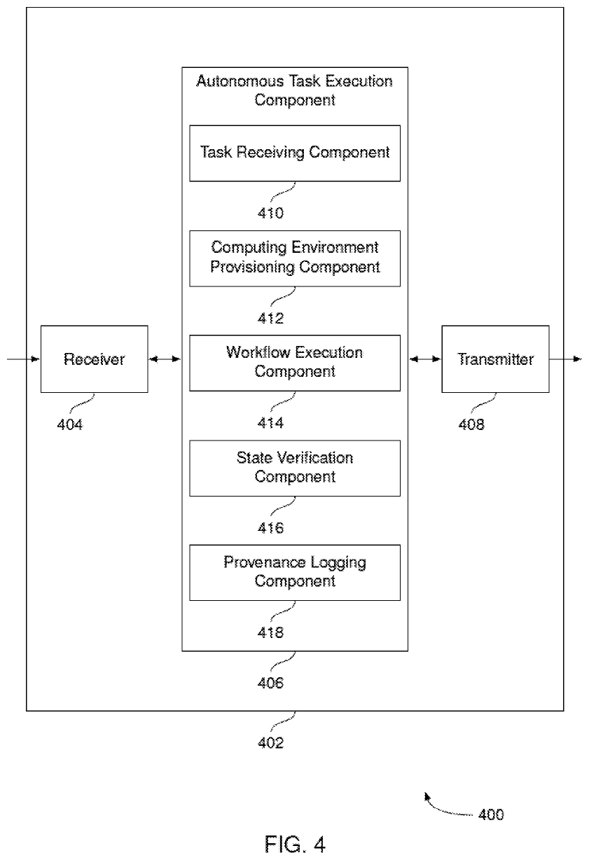

FIG. 4 shows a block diagram 400 of an apparatus 402 that supports autonomously executing tasks with perception and secure provenance in computing environments in accordance with various aspects of the present disclosure. The apparatus 402 may include an input module 404, autonomous task execution component 406, and an output module 408. The apparatus 402 may also include a processor. Each of these components may be in communication with one another (e.g., via one or more buses). In some cases, the apparatus 402 may be an example of a user terminal, a database server, or a system containing multiple computing devices.

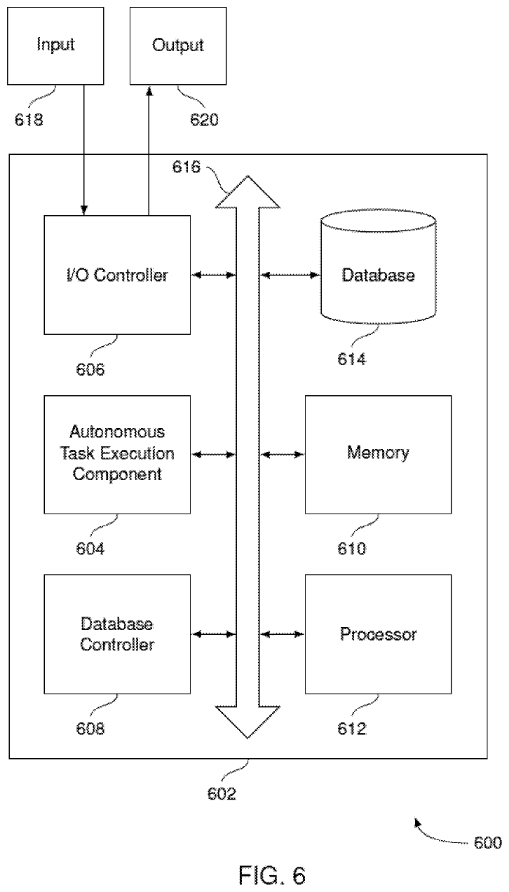

The input module 404 may manage input signals for the apparatus 402. For example, the input module 404 may identify input signals based on an interaction with a modem, a keyboard, a mouse, a touchscreen, or a similar device. These input signals may be associated with user input or processing at other components or devices. In some cases, the input module 404 may utilize an operating system such as iOS, ANDROID, MS-DOS, MS-WINDOWS, OS/2, UNIX, LINUX, or another known operating system to handle input signals. The input module 404 may send aspects of these input signals to other components of the apparatus 402 for processing. In some cases, the input module 404 may be a component of an input/output (I/O) controller 606 as described with reference to FIG. 6.

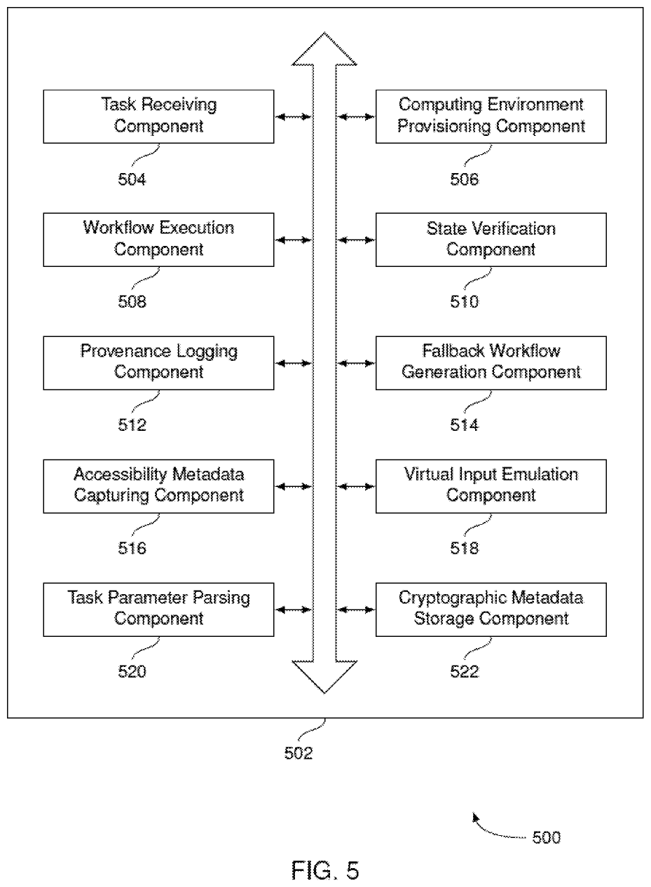

The autonomous task execution component 406 may include one or more of a task receiving component 410, a computing environment provisioning component 412, a workflow execution component 414, a state verification component 416, a provenance logging component 418, and/or other components. The autonomous task execution component 406 may be an example of aspects of the autonomous task execution component 502 or 604 described with reference to FIGS. 5 and 6.

The task receiving component 410 may be configured as or otherwise support a means for receiving, at a server platform, input data representing a task to be performed by an artificial intelligence agent. The computing environment provisioning component 412 may be configured as or otherwise support a means for provisioning, by the server platform, a computing environment including an operating system configured to receive synthetic input events and a perception layer configured to capture pre-execution and post-execution states of the operating system. The workflow execution component 414 may be configured as or otherwise support a means for executing, within the computing environment, a workflow representation of the task by generating the synthetic input events. The state verification component 416 may be configured as or otherwise support a means for verifying, by the perception layer, state transitions based on the captured pre-execution and post-execution states. The provenance logging component 418 may be configured as or otherwise support a means for logging, in a provenance module of the server platform, each synthetic input event and corresponding verified state transition, the log including cryptographic metadata associated with the task.

The output module 408 may manage output signals for the apparatus 402. For example, the output module 408 may receive signals from other components of the apparatus 402, such as the autonomous task execution component 406, and may transmit these signals to other components or devices. In some specific examples, the output module 408 may transmit output signals for display in a user interface, for storage in a database or data store, for further processing at a server or server cluster, or for any other processes at any number of devices or systems. In some cases, the output module 408 may be a component of an I/O controller 606 as described with reference to FIG. 6.

FIG. 5 shows a block diagram 500 of an autonomous task execution component 502 that supports autonomously executing tasks with perception and secure provenance in computing environments in accordance with various aspects of the present disclosure. The autonomous task execution component 502 may be an example of aspects of an autonomous task execution component 406, an autonomous task execution component 604, or both, as described herein. The autonomous task execution component 502, or various components thereof, may be an example of means for performing various aspects of autonomously executing tasks with perception and secure provenance in computing environments as described herein. For example, the autonomous task execution component 502 may include one or more of a task receiving component 504, a computing environment provisioning component 506, a workflow execution component 508, a state verification component 510, a provenance logging component 512, a fallback workflow generation component 514, an accessibility metadata capturing component 516, a virtual input emulation component 518, a task parameter parsing component 520, a cryptographic metadata storage component 522, and/or other components. Each of these components may communicate, directly or indirectly, with one another (e.g., via one or more buses).

The task receiving component 504 may be configured as or otherwise support a means for receiving, at a server platform, input data that may represent a task to be performed by an artificial intelligence agent. In some implementations, the task receiving component 504 may receive input data in the form of natural language descriptions submitted through a user interface. The task receiving component 504 may, in some cases, accept input data derived from structured documents, such as spreadsheets or configuration files. The task receiving component 504 may further support receiving input data transmitted via an API endpoint, which may include task parameters encoded in JSON or XML formats. In some implementations, the task receiving component 504 may handle input data that originates from external systems, such as enterprise ticketing platforms or help desk systems. The task receiving component 504 may, in certain cases, process input data that includes metadata tags describing task priorities or dependencies.

The computing environment provisioning component 506 may be configured as or otherwise support a means for provisioning, by the server platform, a computing environment that may include an operating system that may be configured to receive synthetic input events and a perception layer that may be configured to capture pre-execution and post-execution states of the operating system. In some implementations, the operating system may support synthetic input events such as cursor movements, keystrokes, mouse clicks, touch gestures, or command-line inputs. The operating system may, in certain cases, include APIs or hooks that may allow synthetic input events to be injected programmatically. The perception layer may, in some implementations, capture pre-execution and post-execution states through screenshots that may be stored in a temporary buffer for analysis. The perception layer may, in certain cases, include modules that may perform optical character recognition (OCR) on captured screenshots to detect text-based changes in the operating system state. The perception layer may, in some implementations, analyze accessibility tree metadata to determine structural changes in the user interface of the operating system.

The workflow execution component 508 may be configured as or otherwise may support a means for executing, within the computing environment, a workflow representation of the task by generating the synthetic input events. In some implementations, the workflow execution component 508 may generate synthetic input events such as mouse clicks to interact with graphical user interface elements, including buttons or checkboxes. The workflow execution component 508 may, in certain cases, generate keyboard inputs to populate text fields or execute command-line instructions. In some implementations, the workflow execution component 508 may generate touch gestures to interact with touchscreen interfaces, such as swiping or pinching motions. The workflow execution component 508 may, in certain cases, generate drag-and-drop actions to move files or interface elements within the computing environment. In some implementations, the workflow execution component 508 may determine the timing of synthetic input events to align with the expected response time of the operating system. The workflow execution component 508 may, in certain cases, generate synthetic input events in sequences that correspond to predefined workflows or dynamically constructed task representations.

The state verification component 510 may be configured as or otherwise support a means for verifying, by the perception layer, state transitions that may be based on the captured pre-execution and post-execution states. In some implementations, the state verification component 510 may determine state transitions by comparing pixel-level differences between pre-execution and post-execution screenshots. The state verification component 510 may, in certain cases, analyze changes in the hierarchical structure of accessibility tree metadata to identify modifications in user interface elements. In some implementations, the state verification component 510 may detect state transitions by identifying text changes through optical character recognition (OCR) applied to captured screenshots. The state verification component 510 may, in certain cases, determine state transitions by analyzing timestamps associated with captured states to identify temporal patterns. In some implementations, the state verification component 510 may verify state transitions by comparing document object model (DOM) attributes extracted from pre-execution and post-execution states.

The provenance logging component 512 may be configured as or otherwise support a means for logging, in a provenance module of the server platform, each synthetic input event and corresponding verified state transition, the log may include cryptographic metadata associated with the task. In some implementations, the provenance logging component 512 may store cryptographic hashes of pre-execution and post-execution states to ensure the integrity of logged data. The provenance logging component 512 may, in certain cases, include metadata such as unique identifiers for the AI agent performing the task. In some implementations, the provenance logging component 512 may log timestamps associated with each synthetic input event to track the sequence of actions. The provenance logging component 512 may, in certain cases, include references to fallback workflows triggered during task execution. In some implementations, the provenance logging component 512 may store logs in a distributed ledger to support tamper-evident recordkeeping. The provenance logging component 512 may, in certain cases, associate each log entry with a task-specific identifier to distinguish between concurrent workflows.

In some examples, the fallback workflow generation component 514 may be configured as or otherwise support a means for generating fallback workflows in response to detecting a failed state transition during the verification by the perception layer, the fallback workflows may include alternative sequences of synthetic input events derived from historical task data stored on the server platform. In some implementations, the fallback workflows may include sequences of synthetic input events that may be determined based on patterns identified in prior successful task executions. In some implementations, the fallback workflow generation component 514 may determine alternative input sequences that may involve different timing intervals between synthetic input events to account for potential delays in the operating system's response. In some implementations, the fallback workflows may include input sequences that may bypass specific user interface elements identified as problematic during prior task executions. In some implementations, the fallback workflow generation component 514 may determine alternative workflows that may involve substituting keyboard shortcuts for mouse-based interactions to address potential input conflicts. In some implementations, the fallback workflows may include sequences that may incorporate additional synthetic input events to reset the operating system state before retrying the original task sequence.

In some examples, the accessibility metadata capturing component 516 may be configured as or otherwise support a means for capturing accessibility tree metadata as part of the pre-execution and post-execution states, the accessibility tree metadata may include roles, states, and hierarchical relationships of user interface components within the operating system. In some implementations, the accessibility metadata capturing component 516 may capture metadata describing the visibility of user interface components, such as whether a button may be marked as hidden or visible. In some implementations, the accessibility metadata capturing component 516 may determine whether user interface components may be interactive, such as identifying if a checkbox may be enabled or disabled. In some implementations, the accessibility metadata capturing component 516 may capture hierarchical relationships that may indicate parent-child structures, such as a menu item that may belong to a dropdown menu. In some implementations, the accessibility metadata capturing component 516 may capture metadata that may include descriptive labels for user interface components, such as text associated with a button or a tooltip. In some implementations, the accessibility metadata capturing component 516 may determine whether user interface components may support specific accessibility features, such as screen reader compatibility or keyboard navigation.

In some examples, the virtual input emulation component 518 may be configured as or otherwise support a means for emulating virtual input devices to generate the synthetic input events, the virtual input devices may include virtual keyboards, virtual mice, and virtual touchscreens configured to interact with the operating system. In some implementations, the virtual input emulation component 518 may emulate a virtual keyboard to input alphanumeric characters into text fields or command-line interfaces. In some implementations, the virtual input emulation component 518 may simulate a virtual mouse to perform actions such as right-clicking on context menus or double-clicking to open files. In some implementations, the virtual input emulation component 518 may emulate a virtual touchscreen to perform gestures such as pinch-to-zoom or multi-finger swipes for navigation within the operating system. In some implementations, the virtual input emulation component 518 may determine the pressure sensitivity of touch gestures to interact with applications that support pressure-based input. In some implementations, the virtual input emulation component 518 may generate synthetic input events that replicate drag-and-drop actions to rearrange files or interface elements within the operating system.

In some examples, the task parameter parsing component 520 may be configured as or otherwise support a means for parsing input data to extract task parameters, the input data may include documentation, source code, and graphical user interface elements, and constructing the workflow representation may be based on the extracted task parameters. In some implementations, the task parameter parsing component 520 may determine task parameters from structured documents such as spreadsheets or configuration files that may include metadata tags. In some implementations, the task parameter parsing component 520 may analyze natural language descriptions submitted through a user interface to identify task-specific keywords or phrases. In some implementations, the task parameter parsing component 520 may process input data transmitted via an API endpoint, which may include task parameters encoded in formats such as JSON or XML. In some implementations, the task parameter parsing component 520 may extract task parameters from visual interface elements by analyzing screenshots or accessibility tree metadata. In some implementations, the task parameter parsing component 520 may determine relationships between extracted parameters, such as identifying dependencies or priorities based on metadata included in the input data.

In some examples, the cryptographic metadata storage component 522 may be configured as or otherwise support a means for storing cryptographic metadata in a tamper-evident ledger, the cryptographic metadata may include hash values of the pre-execution and post-execution states, timestamps, and unique identifiers associated with the synthetic input events. In some implementations, the cryptographic metadata storage component 522 may store additional metadata, such as the digital signatures of the AI agent performing the task, to associate actions with specific agents. In some implementations, the cryptographic metadata storage component 522 may determine relationships between stored hash values and task-specific identifiers to track workflows across multiple sessions. In some implementations, the cryptographic metadata storage component 522 may include mechanisms to periodically verify the integrity of the tamper-evident ledger by cross-referencing stored hash values with external audit logs.

FIG. 6 shows a diagram of a system 600 including a device 602 that supports autonomously executing tasks with perception and secure provenance in computing environments in accordance with aspects of the present disclosure. The device 602 may be an example of or include the components of a database server or an apparatus 402 as described herein. The device 602 may include components for bi-directional data communications including components for transmitting and receiving communications, including an autonomous task execution component 604, an I/O controller 606, a database controller 608, memory 610, a processor 612, and a database 614. These components may be in electronic communication via one or more buses (e.g., bus 616).

The autonomous task execution component 604 may be an example of an autonomous task execution component 406 or 502 as described herein. For example, the autonomous task execution component 604 may perform any of the methods or processes described above with reference to FIGS. 4 and 5. In some cases, the autonomous task execution component 604 may be implemented in hardware, software executed by a processor, firmware, or any combination thereof.

The I/O controller 606 may manage input signals 618 and output signals 620 for the device 602. The I/O controller 606 may also manage peripherals not integrated into the device 602. In some cases, the I/O controller 606 may represent a physical connection or port to an external peripheral. In some cases, the I/O controller 606 may utilize an operating system such as iOS, ANDROID, MS-DOS, MS-WINDOWS, OS2, UNIX, LINUX, or another known operating system. In other cases, the I/O controller 606 may represent or interact with a modem, a keyboard, a mouse, a touchscreen, or a similar device. In some cases, the I/O controller 606 may be implemented as part of a processor. In some cases, a user may interact with the device 602 via the I/O controller 606 or via hardware components controlled by the I/O controller 606.

The database controller 608 may manage data storage and processing in a database 614. In some cases, a user may interact with the database controller 608. In other cases, the database controller 608 may operate automatically without user interaction. The database 614 may be an example of a single database, a distributed database, multiple distributed databases, a data store, a data lake, or an emergency backup database.

Memory 610 may include random-access memory (RAM) and read-only memory (ROM). The memory 610 may store computer-readable, computer-executable software including instructions that, when executed, cause the processor to perform various functions described herein. In some cases, the memory 610 may contain, among other things, a basic input/output system (BIOS) which may control basic hardware or software operation such as the interaction with peripheral components or devices.

The processor 612 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 612 may be configured to operate a memory array using a memory controller. In other cases, a memory controller may be integrated into the processor 612. The processor 612 may be configured to execute computer-readable instructions stored in a memory 610 to perform various functions (e.g., functions or tasks supporting autonomously executing tasks with perception and secure provenance in computing environments).

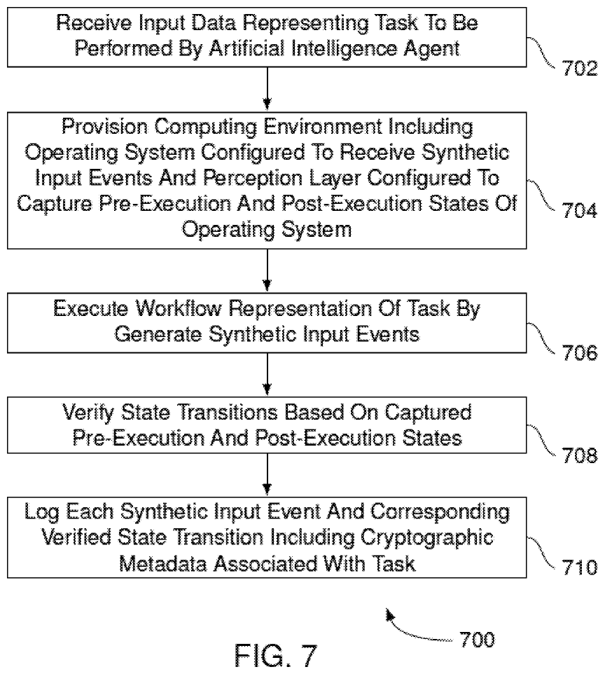

FIG. 7 shows a flowchart illustrating a method 700 that supports autonomously executing tasks with perception and secure provenance in computing environments in accordance with various aspects of the present disclosure. The operations of the method 700 may be implemented by one or more components of a networked computing system as described herein. For example, the operations of the method 700 may be performed by an autonomous task execution component as described with reference to FIGS. 4 through 6. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 702, the method 700 may include receiving, at a server platform, input data representing a task to be performed by an artificial intelligence agent. The operations of 702 may be performed in accordance with examples as disclosed herein. In some examples, aspects of the operations of 702 may be performed by a task receiving component 504 as described with reference to FIG. 5.

At 704, the method 700 may include provisioning, by the server platform, a computing environment including an operating system configured to receive synthetic input events and a perception layer configured to capture pre-execution and post-execution states of the operating system. The operations of 704 may be performed in accordance with examples as disclosed herein. In some examples, aspects of the operations of 704 may be performed by a computing environment provisioning component 506 as described with reference to FIG. 5.

At 706, the method 700 may include executing, within the computing environment, a workflow representation of the task by generating the synthetic input events. The operations of 706 may be performed in accordance with examples as disclosed herein. In some examples, aspects of the operations of 706 may be performed by a workflow execution component 508 as described with reference to FIG. 5.

At 708, the method 700 may include verifying, by the perception layer, state transitions based on the captured pre-execution and post-execution states. The operations of 708 may be performed in accordance with examples as disclosed herein. In some examples, aspects of the operations of 708 may be performed by a state verification component 510 as described with reference to FIG. 5.

At 710, the method 700 may include logging, in a provenance module of the server platform, each synthetic input event and corresponding verified state transition, the log including cryptographic metadata associated with the task. The operations of 710 may be performed in accordance with examples as disclosed herein. In some examples, aspects of the operations of 710 may be performed by a provenance logging component 512 as described with reference to FIG. 5.

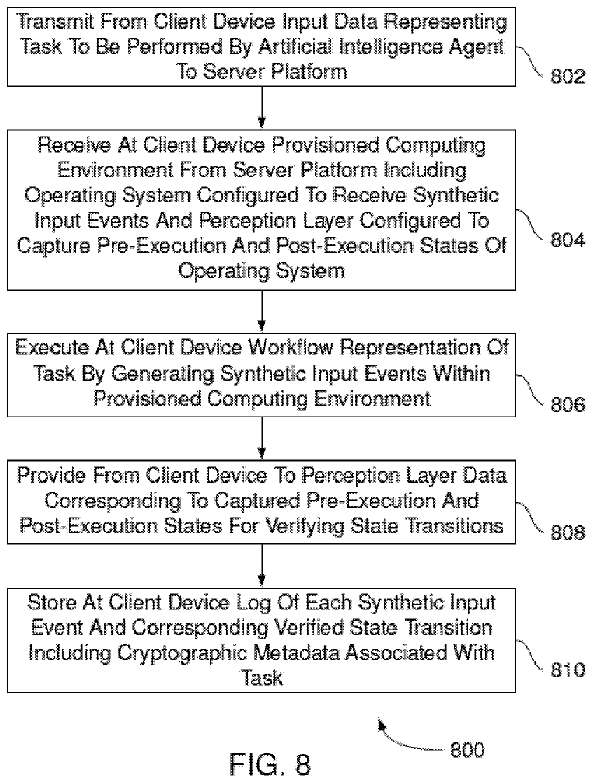

FIG. 8 shows a flowchart illustrating a method 800 that supports autonomously executing tasks with perception and secure provenance in computing environments in accordance with various aspects of the present disclosure. The operations of the method 800 may be implemented by one or more components of a networked computing system as described herein. For example, the operations of the method 800 may be performed by an autonomous task execution component as described with reference to FIGS. 4 through 6. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 802, the method 800 may include transmitting, from a client device, input data representing a task to be performed by an artificial intelligence agent to a server platform. The operations of 802 may be performed in accordance with examples as disclosed herein. In some examples, aspects of the operations of 802 may be performed by a task receiving component 504 as described with reference to FIG. 5.

At 804, the method 800 may include receiving, at the client device, a provisioned computing environment from the server platform, the computing environment including an operating system configured to receive synthetic input events and a perception layer configured to capture pre-execution and post-execution states of the operating system. The operations of 804 may be performed in accordance with examples as disclosed herein. In some examples, aspects of the operations of 804 may be performed by a computing environment provisioning component 506 as described with reference to FIG. 5.

At 806, the method 800 may include executing, at the client device, a workflow representation of the task by generating the synthetic input events within the provisioned computing environment. The operations of 806 may be performed in accordance with examples as disclosed herein. In some examples, aspects of the operations of 806 may be performed by a workflow execution component 508 as described with reference to FIG. 5.

At 808, the method 800 may include providing, from the client device to the perception layer, data corresponding to the captured pre-execution and post-execution states for verifying state transitions. The operations of 808 may be performed in accordance with examples as disclosed herein. In some examples, aspects of the operations of 808 may be performed by a state verification component 510 as described with reference to FIG. 5.

At 810, the method 800 may include storing, at the client device, a log of each synthetic input event and corresponding verified state transition, the log including cryptographic metadata associated with the task. The operations of 810 may be performed in accordance with examples as disclosed herein. In some examples, aspects of the operations of 810 may be performed by a provenance logging component 512 as described with reference to FIG. 5.

### Agent Computing Environments

An “agent computing environment” is a computing domain provisioned for autonomous execution by an AI agent. The environment includes an operating system or equivalent interface capable of receiving OS-level input events such as cursor movements, mouse clicks, keyboard input, touch gestures, scroll operations, and command-line inputs. The environment may be implemented using a virtual machine, a containerized execution environment, a sandboxed server context, or another isolated execution substrate.

The environment exposes one or more event injection mechanisms that translate synthetic events generated by the AI agent into OS-recognized input events. For example, the environment may emulate human interface devices (HID), may issue events via windowing-system APIs, or may use accessibility APIs or browser automation hooks. The environment also exposes perception capabilities that allow the agent to capture and analyze system state.

The agent computing environment is typically instantiated for the exclusive use of a single AI agent or agent instance. This isolation simplifies provenance tracking, security analysis, and error recovery.

### Provisioning of the Agent Execution Domain

When input data representing a task is received, a provisioning component determines whether OS-level interaction is required. If so, the system provisions an agent computing environment.

Provisioning may include instantiating a virtual machine from a template image, launching a container from a base image, or creating an isolated sandbox with a configured operating system. Configuration may include loading specific applications, files, credentials, test datasets, or other resources needed to execute the task.

The environment is configured with permission settings specifying which applications and data the agent may access, as well as network access policies and sandboxing controls. The agent is assigned an identifier that is used to tag provenance logs and to enforce access control within the environment.

In various embodiments, the autonomous agent computing environment is implemented on any local operating system, including desktop operating systems such as Windows, macOS, or Linux, mobile operating systems such as iOS or Android, and local virtual-machine or container-based operating systems. In each case, the artificial intelligence agent injects operating-system-level input events, including cursor movements, mouse clicks, keyboard input, touch gestures, scroll operations, and command-line instructions, directly into the local operating system. A perception layer captures local state rendered by the operating system, including screens, windows, document object model structures, and accessibility trees, and verifies that expected state transitions occurred. These embodiments are collectively referred to as local operating system embodiments and may operate without requiring remote-desktop protocols, cloud-hosted desktops, or remote operating-system sessions, although in other embodiments remote desktop sessions or cloud-hosted desktops are used.

### Workflow Generation

A workflow generation engine constructs a workflow representation for the task. The engine may parse source code, unit tests, configuration files, or documentation; may analyze natural language task descriptions; and may perform autonomous exploration of user interfaces to infer available actions and transitions.

The workflow representation may be expressed as an ordered list of OS-level input events and expected state transitions, as a flowchart, or as a structured graph. Each step may include conditions, branches, fallback paths, and error-handling triggers.

When source code is available, static and dynamic code analysis may extract meta tags, dependency information, and task parameters. When source code is not available, the system may rely on screenshots, OCR, accessibility trees, and DOM structures to infer workflows.

### Os-Level Event Execution

Within the agent computing environment, a workflow execution component generates OS-level input events specified by the workflow representation. Events may include moving the cursor to a UI element and clicking, entering text strings, activating keyboard shortcuts, scrolling, dragging elements, uploading files, or invoking command-line commands.

The execution engine may emulate virtual keyboards, mice, or touchscreens, and may interact with OS-level APIs or application-level automation interfaces. Timing parameters, such as delays between events, may be selected based on historical performance data or dynamic feedback from the perception layer.

### Perception-Based State Verification

A perception layer captures pre-execution and post-execution states of the environment around each event or group of events. In various embodiments, the perception layer acquires:
(A) Screenshots Or Frame Buffer Contents;
(B) Ocr Text Extracted From Screenshots;
(C) accessibility tree snapshots describing roles, labels, states, and hierarchies of UI elements;
(D) Dom Structures And Attributes For Browser-Based Applications;
(E) Metadata Regarding Active Windows, Dialog Boxes, And Focus.

The perception layer compares the post-execution state to an expected state encoded in the workflow representation. State verification may include simple checks, such as confirming that a particular string appears on the screen, or more complex structural checks on accessibility or DOM trees. If the expected state is observed, the workflow proceeds. If verification fails, error-handling logic is invoked.

### Cryptographic Provenance Logging

A provenance module maintains a tamper-evident record of events and state transitions. For each input event or sequence of events, the module records:
(A) An Event Identifier;
(B) Event Parameters;
(C) Timestamps;
(D) Hashes of pre-execution and post-execution state data or summaries;
(E) The Associated Workflow Identifier; And
(F) The Agent Identifier.

The module may store entries in a ledger that uses cryptographic hash chaining, digital signatures, or other mechanisms to detect modification. Logs may be kept locally, replicated to a server, or stored in a distributed ledger.

### Structured Ui Mapping, Workflow Graphs, and Dependencies

In some embodiments, the system builds a structured workflow graph from observed actions, state transitions, and task definitions. Graph nodes may represent screens, UI states, or logical task steps. Graph edges may represent transitions, preconditions, or dependencies.

As the agent explores the interface or executes scripted tasks, the system records which actions lead from one state to another, whether particular data fields must be populated, and which screens must be visited to complete a task. The resulting graph can encode multiple alternative paths and error paths.

A dependency mapping component analyzes the graph to identify prerequisite screens, required data values, and ordering relationships. These dependency models support more reliable task execution and can be used to generate user-facing documentation or help flows.

### Multi-Modal Help Desk Generation

A help desk generation engine uses the structured workflow graph and dependency information to produce multi-modal support artifacts. Outputs may include:
(A) Step-By-Step Textual Instructions;
(B) Voice Scripts Or Synthesized Audio Explanations;
(C) Diagrams Showing State Transitions;
(D) Screenshots Or Ui Snippets With Annotations; And
(E) Composite Explanations That Combine Text, Diagrams, And Images.

Multi-modal outputs can be tailored to specific user roles or expertise levels and can be automatically updated when workflows change, because they are generated from the same underlying representations used for autonomous execution.

### Dynamic Workflow Adaptation And Fallback Paths

When the perception layer detects a deviation between expected and actual state, an adaptation component updates the workflow. Adaptation may include retrying an action, inserting additional steps, or switching to an alternative path encoded in the workflow graph.

A fallback workflow generation component may learn from prior execution histories. For example, if a particular menu path fails because a dialog changes, a previously successful alternative path can be selected. Machine learning models may rank candidate fallback sequences based on past success rates.

### Operation Without Source Code

The agent computing environment is particularly valuable in cases where source code is unavailable or where direct integration is impractical. In such cases, the agent relies on screenshots, OCR, accessibility trees, and other perception techniques to identify UI elements and track task progress.

Autonomous exploration may include clicking on candidate UI elements, observing resulting states, and building a map of available screens and transitions. Error messages detected via OCR or accessibility metadata may trigger adjustments to the exploration strategy. This UI-only operation mode allows tasks to be automated in legacy systems, third-party platforms, and proprietary applications without requiring APIs or instrumentation.

### Operation With Source Code and Documentation

When source code is available, the system can complement UI-based techniques with code-based analysis. Abstract syntax tree (AST) parsing, static analysis, and dynamic analysis can reveal functions, parameters, dependencies, and error conditions. Documentation and FAQs can be parsed to obtain natural-language descriptions of tasks.

Task parameter parsing components can combine these sources to construct workflows that more directly reflect the underlying logic of the application. The agent computing environment then executes these workflows using OS-level events and verifies outcomes via the perception layer.

### Security, Encapsulation, and Isolation

The agent computing environment is typically provisioned as an isolated execution domain with restricted permissions. Isolation techniques may include hypervisors, container sandboxes, restricted file systems, and controlled network access.

Isolation ensures that agent actions do not affect other systems or data outside the execution domain and that provenance logs represent a complete record of actions within the environment. Security monitoring tools may examine logs to detect anomalous behavior or policy violations.

### Networked Operation and Remote Control

The agent computing environment may run on cloud infrastructure, on-premises servers, or other network-connected devices. A remote orchestration system can start and stop environments, assign tasks, retrieve logs, and collect telemetry.

Client devices, such as user desktops or mobile phones, may transmit task descriptions to a server platform, monitor status, and receive multi-modal help desk outputs. In some embodiments, a client device may host the agent computing environment locally, with perception and provenance components running on the device itself, as depicted for example in FIG. 8.

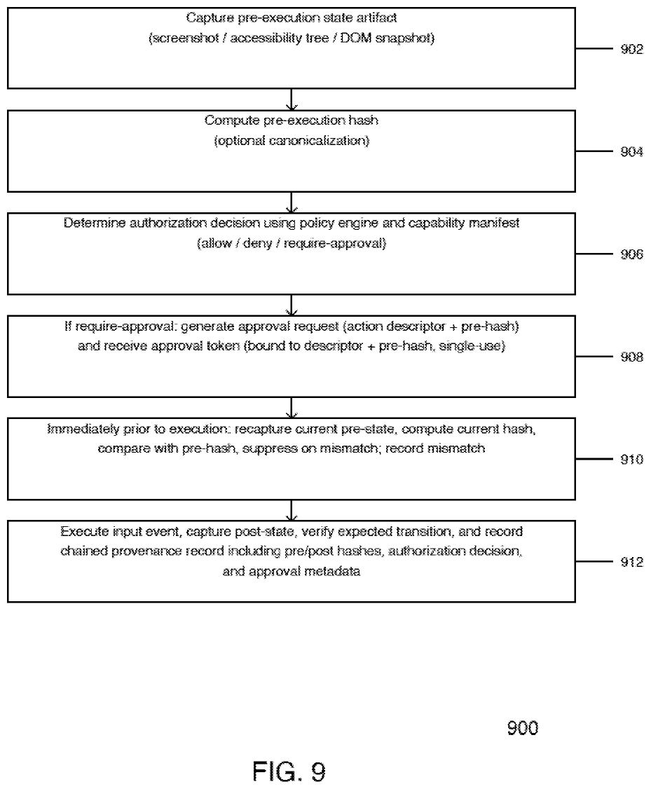

FIG. 9 is a flow diagram illustrating approval-bound execution in which a pre-execution state artifact is hashed, an approval request includes the pre-execution hash, an approval token bound to an action descriptor and the pre-execution hash is validated, a current pre-execution hash is compared prior to execution, and a tamper-evident provenance chain is recorded.

### Device Emulation And Windowing System Interaction

The environment may use a variety of event-injection mechanisms, including driver-level emulation, windowing-system APIs, and accessibility APIs. For example, on certain platforms, OS-level input events may be generated via Win32, X11 or Wayland APIs, macOS event taps, or mobile touchscreen emulators.

These variations are alternative embodiments of the same core concept: the agent computing environment exposes interfaces that allow an AI agent to generate operating-system-level input events.

### Machine Learning Enhancements

Machine learning models may be trained on meta tags derived from code analysis, historical execution sequences, perception-layer snapshots, provenance logs, and prior fallback decisions.

These models may predict which workflows are likely to succeed, estimate the probable outcome of candidate fallback paths, adjust timing parameters, or recommend optimal UI exploration strategies. The models may also be used to rank multi-modal help outputs, select the most relevant examples, or cluster similar tasks.

### Telemetry, Monitoring, Reset, and Replay

The environment may collect telemetry such as CPU usage, memory consumption, timing of perception operations, and integrity checks of the provenance ledger. Telemetry is used for monitoring, scaling decisions, and debugging.

The environment may support snapshot-based reset and replay. Forensic analysis can reconstruct an entire workflow execution from provenance logs and snapshots, allowing auditors to review each step. Workflows may be replayed deterministically to reproduce bugs or verify fixes.

### Multi-Agent Scaling and Orchestration

Multiple autonomous agent computing environments may be provisioned concurrently across data centers, cloud regions, or devices. An orchestration layer may assign tasks, collect results, manage capacity, and coordinate distributed operations.

Each environment maintains its own provenance log, but aggregated analytics may be performed across logs to detect global patterns, optimize workflows, or derive system-wide metrics.

### Api Layer and External Integrations

The system may expose APIs for external systems such as help desk platforms, ticketing systems, CI/CD pipelines, code repositories, and monitoring tools. External systems can submit tasks, query status, retrieve workflow graphs, and access logs through authenticated interfaces.

These integrations allow the agent computing environment to act as a core automation engine within a larger enterprise ecosystem, consistent with the code analysis and help desk integrations described in the parent filings.

### Alternative Embodiments And Advantages

Alternative embodiments may vary in the particular OS platform, perception algorithms, cryptographic mechanisms, or workflow representations used. However, in each case, the agent computing environment provides:
(A) Os-Level Control;
(B) Perception-Based Verification Of Outcomes;
(C) Workflow-Based Execution And Adaptation; And
(D) Cryptographically Verifiable Provenance Logging.

These features deliver advantages over conventional approaches, including improved robustness to UI changes, better auditability, and reliable operation without APIs or source-code access.

### Software Enablement

The autonomous agent computing environment may be implemented using any suitable software architecture that supports injection of operating-system-level input events, perception-based state capture, workflow modeling, and provenance logging. The parent provisional and parent non-provisional applications disclose the core components of this architecture, including OS-level event emitters, screenshot and OCR processing pipelines, accessibility and DOM parsers, workflow generators, fallback planners, and cryptographic metadata storage. The following embodiments provide additional implementation details consistent with those disclosures.

In one implementation, the agent computing environment includes:
a) an event injection module that calls OS APIs such as windowing-system event functions, HID emulators, synthetic keyboard and mouse interfaces, touch gesture emulators, or command-line invocation interfaces;
b) a perception pipeline comprising screenshot capture utilities, OCR engines, DOM inspection utilities, accessibility tree inspection APIs, pixel-difference modules, and UI-component state parsers;
c) a workflow engine that stores a sequence or graph of OS-level events, expected outcomes, conditional branches, and fallback paths;
d) a verification module that compares expected state transitions to observed state transitions using OCR results, accessibility metadata, DOM diffs, or raster-image diffs; and
e) a provenance ledger that stores timestamps, event identifiers, state hashes, workflow identifiers, and agent identity tags in a tamper-evident ledger.

Pseudocode-level examples of OS-level execution are provided below solely for enablement:
Example: Click Action
Move_Cursor(Target_Coordinates)
Emit_Mouse_Event(“Left_Click”)
Captured =Capture_Screen( )
Verify_State_Change(Captured, Expected_State)
Example: Text Entry
Emit_Key_Sequence(“Username123”)
Captured =Capture_Screen( )
Verify_Text_Present(Captured, “Username123”)
Example: Navigation Step
Emit_Keyboard_Shortcut(“Ctrl+P”)
Captured=Capture_Screen( )
Verify_Dialog_Open(Captured, “Preferences”).

These implementations are illustrative and are not limited to any specific software stack. Each embodiment derives directly from the OS-event, perception, workflow, and provenance disclosures of the original Oct. 8, 2024 provisional.

### Alternate Tools, Configurations, And Implementation Variations

Unless stated otherwise, the autonomous agent computing environment is not limited to any specific tool, software library, framework, model, or configuration. Any tool capable of performing the required operations may be used. The following are non-limiting examples of interchangeable alternatives that fall within the originally disclosed embodiments:
a) Any OCR engine, including Tesseract, PaddleOCR, cloud OCR services, or custom OCR models;
b) Any accessibility API or DOM inspection tool available on the target operating system;
c) Any screenshot capture mechanism, including frame buffer access or platform-provided screen-capture APIs;
d) Any workflow representation format, including lists, graphs, directed acyclic graphs, or state machines;
e) Any hash function or cryptographic tool for provenance, including SHA-2, SHA-3, or equivalent mechanisms;
f) Any AI or ML model for workflow generation, including rule-based systems, LLMs, encoder-decoder models, reinforcement-learning agents, or hybrid systems;
g) Any OS platform or local execution substrate, including Windows, macOS, Linux, iOS, Android, VMs, or containers.

These alternatives are illustrative and help avoid unnecessary implementation-specific limitations.

The embodiments described in this application in some embodiments operates on locally executed operating-system environments and in other embodiments operates on remote or cloud-hosted operating-system environments, including desktop operating systems, mobile operating systems, and virtual-machine or container-based operating systems. Other execution substrates or deployment models may be used in related or alternative embodiments not described here.

### Additional Embodiments

The embodiments described herein represent variations that may be implemented within the autonomous agent computing environment disclosed in the parent provisional and non-provisional filings. These embodiments are provided as additional embodiments; they apply the same OS-level event injection, perception-driven state verification, workflow modeling, fallback repair, and cryptographic provenance mechanisms to additional execution scenarios that remain local-operating-system embodiments.

### Surrogate-interface Rendering Embodiment

In some embodiments, the agent computing environment may receive externally generated interface data, including images, pixel buffers, accessibility metadata, UI element descriptors, or document object model structures originating from an external computing system. The environment renders this data locally as a surrogate interface surface for use by the AI agent. The AI agent injects operating-system-level input events into the local operating-system environment, and the perception layer verifies state transitions based on the locally rendered surrogate interface. A translation pipeline may transmit the resulting effects or action metadata to the external system. All workflow execution, input-event injection, perception, verification, and provenance logging occur within the local operating-system instance, and the externally sourced interface data is treated as an input stream rather than as a remote operating-system session. This embodiment is supported in at least some embodiments by the disclosures of screenshot capture, OCR analysis, DOM parsing, accessibility-tree inspection, UI exploration, and event-driven workflow execution in the parent filings, and does not require any remote-desktop protocols or remote operating-system control.

### Multi-Window and Multi-surface Embodiments

The agent computing environment may support multiple local display surfaces or window regions. These may include separate application windows, dialog boxes, tabbed interfaces, or multi-panel software layouts. The perception layer may capture each window independently or as part of a composited image, and workflow steps may target specific windows or surfaces. This is supported by the parent disclosure of screenshot capture, pixel-region comparison, and UI-state validation.

### Composite Perception Embodiments

In some embodiments, the perception layer may combine multiple information sources, such as screenshots, OCR output, accessibility roles, DOM nodes, UI element attributes, and prior execution history. These combined features may be used to perform state verification, identify available UI actions, detect unexpected states, or guide task recovery. These embodiments derive from the originally disclosed multi-modal perception techniques described in the parent applications.

### Workflow Reduction and Optimization Embodiments

The agent may generate alternative workflows that achieve the same task and may reduce or optimize these workflows by removing unnecessary steps, merging adjacent steps, or reordering actions as long as the resulting workflow matches expected UI states. These embodiments follow from the workflow generation, fallback, and dynamic adaptation mechanisms disclosed in the parent filings.

### Local Simulation and Preview Embodiments

The agent computing environment may include a preview mode in which the agent simulates execution of a workflow without performing the underlying OS-level actions. Screenshots, UI metadata, or previously captured states may be used to display expected outcomes. This derives from the perception-layer capture and state-comparison disclosures of the parent filings.

### Fallback Repair and Recovery Embodiments

If a workflow step does not result in the expected state, the agent may select alternative sequences of OS-level input events, revert to a prior state, retry an action with modified timing, or employ a previously successful path recorded in the provenance logs. These embodiments follow directly from the fallback workflow and adaptive repair mechanisms described in the parent filings.

### Multi-Agent Coordination Embodiments

Multiple agent computing environments may operate in parallel to perform identical or distinct workflows. In some cases, agents may exchange workflow metadata, fallback outcomes, or perception-derived insights to improve reliability. All agents execute within their own local operating-system environments and maintain their own provenance logs. This is supported by the parent disclosure of distributed workflow execution and multi-environment architectures.

### Model-Assisted State Prediction Embodiments

Machine-learning models may predict expected future states, expected UI transitions, or the likelihood of success for particular action sequences. Predicted states may be compared against observed states to detect anomalies or guide fallback behavior. These embodiments are supported by the parent disclosures describing task prediction, LLM-based analysis, and adaptive correction.

### Workflow Graph Variants

Workflow representations may take the form of directed graphs, state machines, lists of actions, tree structures, or hybrid forms. Nodes may represent screens, UI states, or logical actions, and edges may represent transitions, dependencies, or error paths. These variants correspond to the workflow extraction, dependency mapping, and structured workflow graph disclosures of the parent applications.

### Enhanced Provenance Logging Variants

The provenance module may use event-level hashing, state-level hashing, chained hash structures, or other tamper-evident metadata techniques. Log entries may include timing metadata, screen hashes, accessibility-tree summaries, fallback indicators, or other contextual information. These embodiments derive from the cryptographic provenance and audit-trail mechanisms disclosed in the parent filings.

### USE CASE EXAMPLES

The following examples illustrate representative tasks that the autonomous agent computing environment may perform. These use cases derive directly from the automation, UI-exploration, perception-layer, and help-desk disclosures of the Oct. 8, 2024 provisional and the parent non-provisional.

### Example 1: Software Configuration

The agent opens a configuration dialog, navigates through tabs, updates fields, saves changes, and validates that the new state is reflected in the interface.

### Example 2: Application Onboarding Workflow

The agent completes a multi-step wizard by clicking Next buttons, entering required data, detecting validation errors, correcting fields, and verifying that the wizard progresses to completion.

### Example 3: Data Entry and Verification

The agent enters information into a structured form, scrolls through fields, triggers dropdown elements, captures screenshots of each completed section, and verifies error messages using OCR.

### Example 4: Account Creation or Login

The agent types credentials, clicks buttons, detects 2FA prompts using OCR or accessibility metadata, and verifies successful login via expected UI state transitions.

### Example 5: Help Desk Content Generation

After executing a workflow, the perception layer captures screen transitions. A multi-modal help engine generates step-by-step instructions, annotated screenshots, and textual explanations of each step.

### Example 6: Code-Supported Workflow Extraction

When source code is provided, the agent parses code, identifies functions or UI handlers, maps dependency relationships, and constructs a workflow graph that is then executed using OS-level events.

These examples do not introduce new functionality; they merely illustrate the capabilities already described in the original filings and now organized into the autonomous agent computing environment.

It should be noted that the methods described herein describe possible implementations, and that the operations and the steps may be rearranged or otherwise modified and that other implementations are possible. Furthermore, aspects from two or more of the methods may be combined.

Aspect 1: A method for autonomously executing tasks with perception and secure provenance in computing environments, comprising: receiving, at a server platform, input data representing a task to be performed by an artificial intelligence agent; provisioning, by the server platform, a computing environment including an operating system configured to receive synthetic input events and a perception layer configured to capture pre-execution and post-execution states of the operating system; executing, within the computing environment, a workflow representation of the task by generating the synthetic input events; verifying, by the perception layer, state transitions based on the captured pre-execution and post-execution states; and logging, in a provenance module of the server platform, each synthetic input event and corresponding verified state transition, the log including cryptographic metadata associated with the task.

Aspect 2: The method of aspect 1, further comprising generating fallback workflows in response to detecting a failed state transition during the verification by the perception layer, the fallback workflows including alternative sequences of synthetic input events derived from historical task data stored on the server platform.

Aspect 3: The method of any of aspects 1 through 2, further comprising capturing accessibility tree metadata as part of the pre-execution and post-execution states, the accessibility tree metadata including roles, states, and hierarchical relationships of user interface components within the operating system.

Aspect 4: The method of any of aspects 1 through 3, further comprising emulating virtual input devices to generate the synthetic input events, the virtual input devices including virtual keyboards, virtual mice, and virtual touchscreens configured to interact with the operating system.

Aspect 5: The method of any of aspects 1 through 4, further comprising parsing input data to extract task parameters, the input data including documentation, source code, and graphical user interface elements, and constructing the workflow representation based on the extracted task parameters.

Aspect 6: The method of any of aspects 1 through 5, further comprising storing cryptographic metadata in a tamper-evident ledger, the cryptographic metadata including hash values of the pre-execution and post-execution states, timestamps, and unique identifiers associated with the synthetic input events.

Aspect 7: The method of any of aspects 1 through 6, wherein the perception layer verifies state transitions by comparing pre-execution and post-execution states through pixel-difference analysis of screenshots captured within the computing environment.

Aspect 8: The method of any of aspects 1 through 7, wherein the workflow representation includes conditional branches that are executed in response to detecting unexpected states during the verification by the perception layer.

Aspect 9: The method of any of aspects 1 through 8, wherein the synthetic input events include sequences of keyboard shortcuts configured to interact with application interfaces within the operating system.

Aspect 10: The method of any of aspects 1 through 9, wherein the provenance module associates cryptographic metadata with a unique workflow identifier corresponding to the task being executed within the computing environment.

Aspect 11: The method of any of aspects 1 through 10, wherein the perception layer captures pre-execution and post-execution states by analyzing hierarchical relationships of graphical elements rendered within the operating system.

Aspect 12: The method of any of aspects 1 through 11, wherein the synthetic input events include touch gestures configured to interact with virtualized mobile operating system interfaces provisioned within the computing environment.

Aspect 13: The method of any of aspects 1 through 12, wherein the workflow representation includes fallback sequences of synthetic input events that are selected in response to detecting errors during the execution of the task.

Aspect 14: A system for autonomously executing tasks with perception and secure provenance in computing environments, comprising a processor; memory coupled with the processor; and instructions stored in the memory and executable by the processor to cause the system to perform a method of any of aspects 1 through 13.

Aspect 15: A system for autonomously executing tasks with perception and secure provenance in computing environments, comprising at least one means for performing a method of any of aspects 1 through 13.

Aspect 16: A non-transitory computer-readable medium storing code for autonomously executing tasks with perception and secure provenance in computing environments, the code comprising instructions executable by a processor to perform a method of any of aspects 1 through 13.

### Additional Embodiments-Security-Hardened Approval-Bound Execution and Anti-Workaround Features

In some embodiments, the systems described herein include a security control plane that reduces risks associated with always-on agent operation, including unauthorized actions, prompt injection, credential leakage, exposed control interfaces, and unsafe tool invocation. The security control plane may be implemented by an agent gateway that receives agent requests from one or more remote interfaces and binds each request to a session context including one or more of a user identity, a device identity, a role, an authorization scope, a time window, and an execution policy.

In some embodiments, the agent gateway uses a policy engine and a capability manifest to determine whether a candidate operating-system-level input event is authorized prior to execution. The policy engine may output an authorization decision comprising allow, deny, or require-approval. When the authorization decision is deny, the system suppresses execution of the candidate input event and records a denial record in a provenance module with cryptographic metadata.

In some embodiments, the capability manifest defines one or more authorized action classes and one or more resource scopes. An action class may be a category label assigned to an operating-system-level input event or a tool invocation based on a risk profile, a privilege level, or expected side effects. In some embodiments, the policy engine maps an action descriptor for a candidate operating-system-level input event to an action class and applies an authorization rule for that action class.

In some embodiments, one or more action classes are designated as high-risk action classes for which require-approval is the default authorization decision unless an explicit allow rule applies. Non-limiting examples of high-risk action classes include at least one of: (i) deleting data, (ii) transmitting data externally, (iii) executing a system command, (iv) modifying permissions, and (v) changing a credential.

In some embodiments, when the authorization decision is deny or require-approval, the policy engine provides a policy reason code that identifies a policy rule, a violation category, or a risk classification associated with the authorization decision. The policy reason code may be a structured identifier including at least one of a numeric code, an alphanumeric code, a rule identifier, or a namespace-qualified string. In some embodiments, the denial record stored in the provenance module includes the authorization decision, the policy reason code, the action descriptor, and the pre-execution hash.

In some embodiments, mapping the action descriptor to the action class includes extracting one or more of an event type, a target application identifier, a target resource identifier, a privilege level, a data classification, or a network destination from the action descriptor, and selecting an action class identifier using an action classification table that maps descriptor attributes to action classes.

In some embodiments, the policy reason code is selected from a predetermined enumeration that is stable across policy updates and is suitable for automated compliance reporting. Non-limiting examples include:
POLICY.DENY.OUT_OF_SCOPE_RESOURCE,
POLICY.DENY.UNTRUSTED_DERIVATION,
POLICY.REQUIRE_APPROVAL.HIGH_RISK_DELETE,
POLICY.REQUIRE_APPROVAL.HIGH_RISK_EXTERNAL_TRANSMIT,
POLICY.DENY. MISSING_CAPABILITY, and
POLICY.DENY_PREHASH_MISMATCH.

In some embodiments, the policy reason code is recorded without including sensitive data, and evidence is referenced via a hash or pointer to a state artifact stored in the provenance module.

In some embodiments, when the authorization decision is require-approval, the system captures, by a perception layer, a pre-execution state artifact comprising at least one of a screenshot, an accessibility tree snapshot, or a document object model snapshot, and computes a pre-execution hash of the pre-execution state artifact. The system generates an approval request that includes (i) an action descriptor for the candidate input event and (ii) the pre-execution hash. The system pauses execution until an approval token is received.

In some embodiments, an action descriptor is a structured representation of a candidate operating-system-level input event. Non-limiting examples of fields include: (i) an event type, (ii) a target application identifier, (iii) a target element identifier derived from at least one of a screenshot, an accessibility tree snapshot, or a document object model snapshot, and (iv) event parameters comprising at least one of a text payload, a key code, pointer coordinates, or modifier keys. In some embodiments, the approval request includes a digest of the action descriptor in addition to, or instead of, a raw serialization of the action descriptor.

In some embodiments, the approval token is cryptographically bound to at least the action descriptor and the pre-execution hash, and the approval token is single-use. In some embodiments, the approval token is further bound to at least one of a session identifier, a resource scope, or a time window, and the approval token is rejected when the time window expires or when the session identifier does not match.

In some embodiments, validating the approval token includes verifying a cryptographic authentication value of the approval token and verifying that the approval token payload matches the approval request. In some embodiments, the cryptographic authentication value comprises at least one of a digital signature or a message authentication code over a token payload that includes at least an action descriptor digest and the pre-execution hash. In some embodiments, the token payload further includes at least one of a token identifier, an issuer identifier, an expiration time, a session identifier, or a resource scope.

In some embodiments, single-use enforcement is implemented by maintaining a consumed-token registry that stores token identifiers for consumed approval tokens. In some embodiments, the system marks an approval token as consumed after successful validation and suppresses execution when a token identifier is present in the consumed-token registry, thereby rejecting token replay. In some embodiments, a denial record is recorded in the provenance module with a policy reason code indicating token replay or token invalidity.

In some embodiments, immediately prior to executing the approved input event, the system recaptures a current pre-execution state artifact and computes a current pre-execution hash, and suppresses execution when the current pre-execution hash does not match the pre-execution hash included in the approval request. In some embodiments, the system records a mismatch record in the provenance module that includes both the approved pre-execution hash and the current pre-execution hash.

In some embodiments, the system canonicalizes the pre-execution state artifact prior to hashing to reduce sensitivity to dynamic user interface content. Non-limiting examples of canonicalization include masking or ignoring regions associated with timestamps, advertisements, animations, session-specific banners, cursor position, or other dynamic content, normalizing layout coordinates, and normalizing text rendering. In some embodiments, the pre-execution hash is computed from the canonicalized representation.

In some embodiments, after execution of an approved input event, the perception layer captures a post-execution state artifact and verifies whether an expected state transition occurred. In some embodiments, verification uses at least one of structural comparison of accessibility tree hierarchies, image differencing, optical character recognition outputs, or document object model comparison. The provenance module records a provenance record that includes (i) the input event or a hash thereof, (ii) the pre-execution hash, (iii) a post-execution hash, (iv) the authorization decision, and (v) approval metadata including a token identifier. In some embodiments, the provenance module generates a tamper-evident provenance chain by hashing records and chaining record hashes in sequence.

In some embodiments, the system performs periodic anchoring of a batch hash of the tamper-evident provenance chain to an external verification mechanism, including a distributed ledger, a decentralized database, or an external timestamping service. In some embodiments, an audit interface verifies chain integrity by recomputing record hashes, validating the anchor identifiers, and reconstructing pre-execution and post-execution state artifacts referenced by provenance records.

In some embodiments, the system records agent identity metadata in provenance records, including an agent identifier and optional digital signature metadata for an agent instance. In some embodiments, approval tokens are bound to agent identity metadata to prevent substitution of a different agent executor after approval.

In some embodiments, the system classifies content used during planning as trusted or untrusted and prevents untrusted content from directly determining operating-system-level input events or tool invocation parameters without validation by the policy engine. In some embodiments, when a planned input event is derived from untrusted content and targets a resource outside a resource scope defined by the capability manifest, the authorization decision is require-approval.

In some embodiments, the system validates integrity of at least one of a workflow package or a tool definition prior to execution by verifying a version-pinned hash and recording an integrity identifier in the provenance record. When integrity validation fails, the system suppresses execution and records an integrity violation record with cryptographic metadata. In some embodiments, integrity validation includes verifying a publisher identity attestation or a build provenance identifier.

In some embodiments, the system includes a secret broker and a secret store configured to prevent raw secrets from being placed in a model context. Raw secrets include passwords, API keys, access tokens, private keys, session cookies, and refresh tokens. The secret broker provides an opaque handle or a short-lived scoped credential to tool invocation infrastructure, and tool outputs are filtered to remove secret material prior to inclusion in a model context. Secret access events may be recorded in provenance records without recording raw secret values.

In some embodiments, operating-system-level execution occurs within a local desktop operating system, a containerized workspace, a virtual machine, a sandbox, or a cloud-hosted environment. A remote interface may present an interactive surface, including a browser-based IDE or a remote desktop session. In remote desktop embodiments, the perception layer captures pre-execution and post-execution state artifacts from a remote session display surface, and operating-system-level input events are injected into the remote session while maintaining approval binding, hash-match gating, and provenance semantics.

In some embodiments, the workflow representation supports dual-plane execution in which edges of a workflow graph include at least one of (i) operating-system-level input events and (ii) application programming interface (API) invocations. In such embodiments, the policy engine authorizes or suppresses API invocations based on the capability manifest and records authorization decisions and execution evidence in the provenance module with cryptographic metadata. In some embodiments, selected API invocations require approval and are bound to an action descriptor and a hash of a captured pre-execution state artifact that represents an API-visible precondition state.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for hardened automation of operating-system-level tasks by an artificial intelligence (AI) agent, comprising:
receiving, at an agent gateway, an agent request from a remote interface and binding the agent request to a session context;
constructing, based on the agent request, a workflow representation comprising (i) a sequence of operating-system-level input events and (ii) expected state transitions associated with the operating-system-level input events;
capturing, by a perception layer, prior to executing a first operating-system-level input event, a pre-execution state artifact comprising one or more of (i) a screenshot or (ii) an accessibility tree snapshot;
computing a pre-execution hash of the pre-execution state artifact;
determining, by a policy engine and based on at least a capability manifest for the session context, an authorization decision for the first operating-system-level input event, the authorization decision selected from an allow decision, a deny decision, and a require-approval decision;
suppressing execution of the first operating-system-level input event and recording a denial record in a provenance module, in response to the authorization decision being the deny decision;
responding to the authorization decision being the require-approval decision:
(a) generating an approval request that includes (i) an action descriptor for the first operating-system-level input event and (ii) the pre-execution hash, and pausing execution until an approval token is received;
(b) receiving an approval token that is cryptographically bound to at least the action descriptor and the pre-execution hash, wherein the approval token is single-use; and
(c) validating the approval token; and
(d) recapturing, by the perception layer, immediately prior to executing the first operating-system-level input event, a current pre-execution state artifact and computing a current pre-execution hash, and suppressing execution when the current pre-execution hash does not match the pre-execution hash included in the approval request;
executing the first operating-system-level input event, in response to the authorization decision being the allow decision, or in response to validation of the approval token and a match between the current pre-execution hash and the pre-execution hash included in the approval request;
capturing, by the perception layer, a post-execution state artifact;
verifying, based on the post-execution state artifact and the expected state transition associated with the first operating-system-level input event specified by the workflow representation, that the expected state transition occurred; and
recording, in the provenance module, a provenance record that includes one or more of (i) the first operating-system-level input event or a hash thereof, (ii) the pre-execution hash, (iii) a post-execution hash of the post-execution state artifact, (iv) the authorization decision, or (v) approval metadata when require-approval was used,
wherein the provenance module generates a tamper-evident provenance chain by hashing provenance records and chaining record hashes in sequence.

2. The method of claim 1, wherein verifying that the expected state transition occurred comprises comparing one or more of (i) screenshots, (ii) accessibility tree snapshots, (iii) document object model snapshots, or (iv) optical character recognition outputs derived from the pre-execution state artifact and the post-execution state artifact.

3. The method of claim 1, wherein the pre-execution hash is computed from a canonicalized representation of the pre-execution state artifact that excludes at least one of timestamps, advertisements, or session-specific dynamic content.

4. The method of claim 1, wherein the capability manifest defines (i) authorized action classes and (ii) resource scopes, and determining the authorization decision includes mapping the first operating-system-level input event to an action class.

5. The method of claim 4, wherein the authorization decision is require-approval when the first operating-system-level input event is mapped to a high-risk action class comprising one or more of deleting data, transmitting data externally, executing a system command, modifying permissions, or changing a credential.

6. The method of claim 1, wherein validating the approval token comprises:
rejecting the approval token when a time window expires; and
rejecting the approval token when a token identifier of the approval token is present in a consumed-token registry,
wherein the approval token is additionally cryptographically bound to at least one of a session identifier, a resource scope, or the time window.

7. The method of claim 1, wherein the denial record includes the authorization decision, the pre-execution hash, and a policy reason code.

8. The method of claim 1, further comprising, in response to suppressing execution due to a mismatch between the current pre-execution hash and the pre-execution hash included in the approval request, recording a mismatch record in the provenance module that includes the pre-execution hash and the current pre-execution hash.

9. The method of claim 1, further comprising, when verification indicates that the expected state transition did not occur, adapting the workflow representation to include an alternative operating-system-level input event and recording, in the provenance module, a record indicating failed verification, the record including (i) the pre-execution hash and (ii) a post-execution hash of the post-execution state artifact.

10. The method of claim 1, further comprising validating integrity of at least one of a workflow package or a tool definition prior to executing the first operating-system-level input event by verifying a version-pinned hash, and recording an integrity identifier in the provenance record.

11. The method of claim 10, wherein validating integrity includes rejecting execution when integrity validation fails and recording an integrity violation record in the provenance module.

12. The method of claim 1, further comprising accessing a secret stored in a secret store through a secret broker and providing, to a tool invocation infrastructure, an opaque handle or a short-lived scoped credential usable to execute a workflow step without placing a raw secret value into a model context.

13. The method of claim 12, further comprising recording a secret access event in the provenance module without recording the raw secret value.

14. The method of claim 12, further comprising filtering tool outputs prior to inclusion in a model context to remove secret material.

15. The method of claim 1, further comprising classifying content used during planning as trusted or untrusted and requiring that the policy engine validate the first operating-system-level input event against the capability manifest prior to execution when the first operating-system-level input event is derived from untrusted content.

16. A method for hardened automation of operating-system-level tasks by an artificial intelligence (AI) agent, comprising:
obtaining, based on a request from the AI agent, a workflow representation comprising the first operating-system-level input event and an expected state transition associated with the first operating-system-level input event;
capturing, by a perception layer, a pre-execution state artifact comprising at least one of a screenshot or an accessibility tree snapshot and computing a pre-execution hash of the pre-execution state artifact;
generating, by a policy engine, an approval request that includes an action descriptor for the first operating-system-level input event and the pre-execution hash, and pausing execution until an approval token is received;
validating, by the perception layer, the approval token, wherein the approval token is cryptographically bound to at least the action descriptor and the pre-execution hash, and wherein the approval token is single-use;
executing the following steps, immediately prior to executing the first operating-system-level input event, (i) recapturing a current pre-execution state artifact, (ii) computing a current pre-execution hash, and (iii) suppressing execution when the current pre-execution hash does not match the pre-execution hash included in the approval request;
executing the first operating-system-level input event, in response to validation and a match between the current pre-execution hash and the pre-execution hash included in the approval request;
capturing a post-execution state artifact;
verifying, based on the post-execution state artifact and the expected state transition specified by the workflow representation, that the expected state transition occurred; and
recording, in a provenance module, a provenance record that includes (i) the pre-execution hash, (ii) a post-execution hash of the post-execution state artifact, and (iii) approval metadata associated with the approval token,
wherein the provenance module generates a tamper-evident provenance chain by hashing provenance records and chaining record hashes in sequence.

17. A system configured for hardened automation of operating-system-level tasks by an artificial intelligence (AI) agent, comprising:
a processor;
memory coupled with the processor; and
instructions stored in the memory and executable by the processor to cause the system to perform the method, comprising:
receiving, at an agent gateway, an agent request from a remote interface and binding the agent request to a session context;
constructing, based on the agent request, a workflow representation comprising (i) a sequence of operating-system-level input events and (ii) expected state transitions associated with the operating-system-level input events;
capturing, by a perception layer, prior to executing a first operating-system-level input event, a pre-execution state artifact comprising one or more of (i) a screenshot or (ii) an accessibility tree snapshot;
computing a pre-execution hash of the pre-execution state artifact;
determining, by a policy engine and based on at least a capability manifest for the session context, an authorization decision for the first operating-system-level input event, the authorization decision selected from an allow decision, a deny decision, and a require-approval decision;
suppressing execution of the first operating-system-level input event and recording a denial record in a provenance module, in response to the authorization decision being the deny decision;
responding to the authorization decision being the require-approval decision:
(a) generating an approval request that includes (i) an action descriptor for the first operating-system-level input event and (ii) the pre-execution hash, and pausing execution until an approval token is received;
(b) receiving an approval token that is cryptographically bound to at least the action descriptor and the pre-execution hash, wherein the approval token is single-use; and
(c) validating the approval token; and
(d) recapturing, by the perception layer, immediately prior to executing the first operating-system-level input event, a current pre-execution state artifact and computing a current pre-execution hash, and suppressing execution when the current pre-execution hash does not match the pre-execution hash included in the approval request;
executing the first operating-system-level input event, in response to the authorization decision being the allow decision, or in response to validation of the approval token and a match between the current pre-execution hash and the pre-execution hash included in the approval request;
capturing, by the perception layer, a post-execution state artifact;
verifying, based on the post-execution state artifact and the expected state transition associated with the first operating-system-level input event specified by the workflow representation, that the expected state transition occurred; and
recording, in the provenance module, a provenance record that includes one or more of (i) the first operating-system-level input event or a hash thereof, (ii) the pre-execution hash, (iii) a post-execution hash of the post-execution state artifact, (iv) the authorization decision, or (v) approval metadata when require-approval was used,
wherein the provenance module generates a tamper-evident provenance chain by hashing provenance records and chaining record hashes in sequence.

18. The system of claim 17, wherein the instructions are further executable to cause the system to generate the tamper-evident provenance chain by hashing provenance records and chaining record hashes in sequence.

19. The system of claim 17, wherein the instructions are further executable to cause the system to suppress execution when the current pre-execution hash does not match the pre-execution hash included in the approval request and to record a mismatch record in the provenance module.

20. A non-transitory computer-readable medium storing code comprising instructions executable by a processor to perform the method, comprising:
receiving, at an agent gateway, an agent request from a remote interface and binding the agent request to a session context;
constructing, based on the agent request, a workflow representation comprising (i) a sequence of operating-system-level input events and (ii) expected state transitions associated with the operating-system-level input events;
capturing, by a perception layer, prior to executing a first operating-system-level input event, a pre-execution state artifact comprising one or more of (i) a screenshot or (ii) an accessibility tree snapshot;
computing a pre-execution hash of the pre-execution state artifact;
determining, by a policy engine and based on at least a capability manifest for the session context, an authorization decision for the first operating-system-level input event, the authorization decision selected from an allow decision, a deny decision, and a require-approval decision;
suppressing execution of the first operating-system-level input event and recording a denial record in a provenance module, in response to the authorization decision being the deny decision;
responding to the authorization decision being the require-approval decision:
(a) generating an approval request that includes (i) an action descriptor for the first operating-system-level input event and (ii) the pre-execution hash, and pausing execution until an approval token is received;
(b) receiving an approval token that is cryptographically bound to at least the action descriptor and the pre-execution hash, wherein the approval token is single-use; and
(c) validating the approval token; and
(d) recapturing, by the perception layer, immediately prior to executing the first operating-system-level input event, a current pre-execution state artifact and computing a current pre-execution hash, and suppressing execution when the current pre-execution hash does not match the pre-execution hash included in the approval request;
executing the first operating-system-level input event, in response to the authorization decision being the allow decision, or in response to validation of the approval token and a match between the current pre-execution hash and the pre-execution hash included in the approval request;
capturing, by the perception layer, a post-execution state artifact;
verifying, based on the post-execution state artifact and the expected state transition associated with the first operating-system-level input event specified by the workflow representation, that the expected state transition occurred; and
recording, in the provenance module, a provenance record that includes one or more of (i) the first operating-system-level input event or a hash thereof, (ii) the pre-execution hash, (iii) a post-execution hash of the post-execution state artifact, (iv) the authorization decision, or (v) approval metadata when require-approval was used,
wherein the provenance module generates a tamper-evident provenance chain by hashing provenance records and chaining record hashes in sequence.
